(19) United States
(12) Patent Application Publication
(10) Pub. No.: US 2014/0214547 A1
(43) Pub. Date: Jul. 31, 2014

(54) SYSTEMS AND METHODS FOR AUGMENTED RETAIL REALITY

(71) Applicant: R4 Technologies, LLC, Stamford, CT (US)

(72) Inventors: Paul D. Signorelli, Ridgefield, CT (US); Paul T. Breitenbach, Wilton, CT (US); Igor Zhuk, Weston, CT (US); Matthew Breitenbach, Ridgefield, CT (US); Tyler Scott, Ridgefield, CT (US); Julie Pinard, Stamford, CT (US); Colin Marr, Trumbull, CT (US); Adam Meikle, Old Saybrook, CT (US)

(73) Assignee: R4 Technologies, LLC, Stamford, CT (US)

(21) Appl. No.: 14/165,546

(22) Filed: Jan. 27, 2014

Related U.S. Application Data
(60) Provisional application No. 61/756,509, filed on Jan. 25, 2013.

(51) Int. Cl. G06Q 30/02

(52) U.S. Cl. CPC G06Q 30/0267
USPC 705/14.64

(57) ABSTRACT

Systems, apparatus, interfaces, methods, and articles of manufacture that provide for Augmented Retail Reality (ARR).

### CROSS-REFERENCE TO RELATED APPLICATIONS

The present application claims benefit and priority under 35 U.S.C. §120 to, and is a non-provisional application of, U.S. Provisional Patent Application No. 61/756,509 filed on Jan. 25, 2013 and titled “SYSTEMS AND METHODS FOR AUGMENTED REALITY APPLICATIONS”, the contents of which are hereby incorporated by reference herein.

### BACKGROUND

Continued enhancements in mobile electronics and ever-increasing network connectivity and geospatial awareness have contributed to great advances in the usefulness of smart phones, tablets, and other electronic devices. In some cases, for example, images captured and displayed by mobile devices are augmented to overlay virtual representations into what otherwise appears to be an image of the physical world in which a mobile device operates. Such functionality is generally referred to as “Augmented Reality” (AR).

While AR has existed for many years, particularly in military applications such as Heads-Up-Display (HUD) devices, it has only recently been introduced to large numbers of consumer devices. To date, implementations of AR in such consumer electronics have generally been limited to novelties such as simple AR games—e.g., the ability to shoot a virtual basketball into a virtual basketball hoop that appear to be on a wall that a camera of a smart phone is pointed at.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a perspective diagram of an example system according to some embodiments;

FIG. 3A and FIG. 3B are diagrams of an example data storage structure according to some embodiments;

FIG. 4 is a flow diagram of a method according to some embodiments;

FIG. 5 is a block diagram of a system according to some embodiments;

FIG. 6 is a perspective diagram of an example interface according to some embodiments;

FIG. 7 is a block diagram of a system according to some embodiments;

FIG. 8 is a diagram of an example interface according to some embodiments;

FIG. 9 is a flow diagram of a method according to some embodiments;

FIG. 10 is a diagram of an example interface according to some embodiments;

FIG. 11 is a block diagram of a system according to some embodiments;

FIG. 12 is a block diagram of a system according to some embodiments;

FIG. 13 is a perspective diagram of an example interface according to some embodiments;

FIG. 14 is a perspective diagram of an example interface according to some embodiments;

FIG. 15 is a flow diagram of a method according to some embodiments;

FIG. 16 is a block diagram of an apparatus according to some embodiments; and

FIG. 17A, FIG. 17B, FIG. 17C, FIG. 17D, and FIG. 17E are perspective diagrams of exemplary data storage devices according to some embodiments.

### DETAILED DESCRIPTION

Embodiments described herein are descriptive of systems, apparatus, methods, interfaces, and articles of manufacture for AR applications relating to various objects and items such as retail products. Such embodiments may, for example, generally be referred to as Augmented Retail Reality (ARR) applications. Electronic devices implementing ARR may, in some embodiments, provide personalized, geo-targeted, and/or geo-gated advertisements and/or promotions. According to some embodiments, ARR functionality may be utilized to enhance product packaging by supplying virtual supplemental content or may be utilized to manage product inventory such as on store shelves or inside a consumer's refrigerator or pantry. In some embodiments, ARR applications may allow a consumer to seamlessly manage grocery (and/or other product lists) and/or to locate desired products on store shelves. These and many other new and useful applications of ARR and other electronic technologies are described in detail herein.

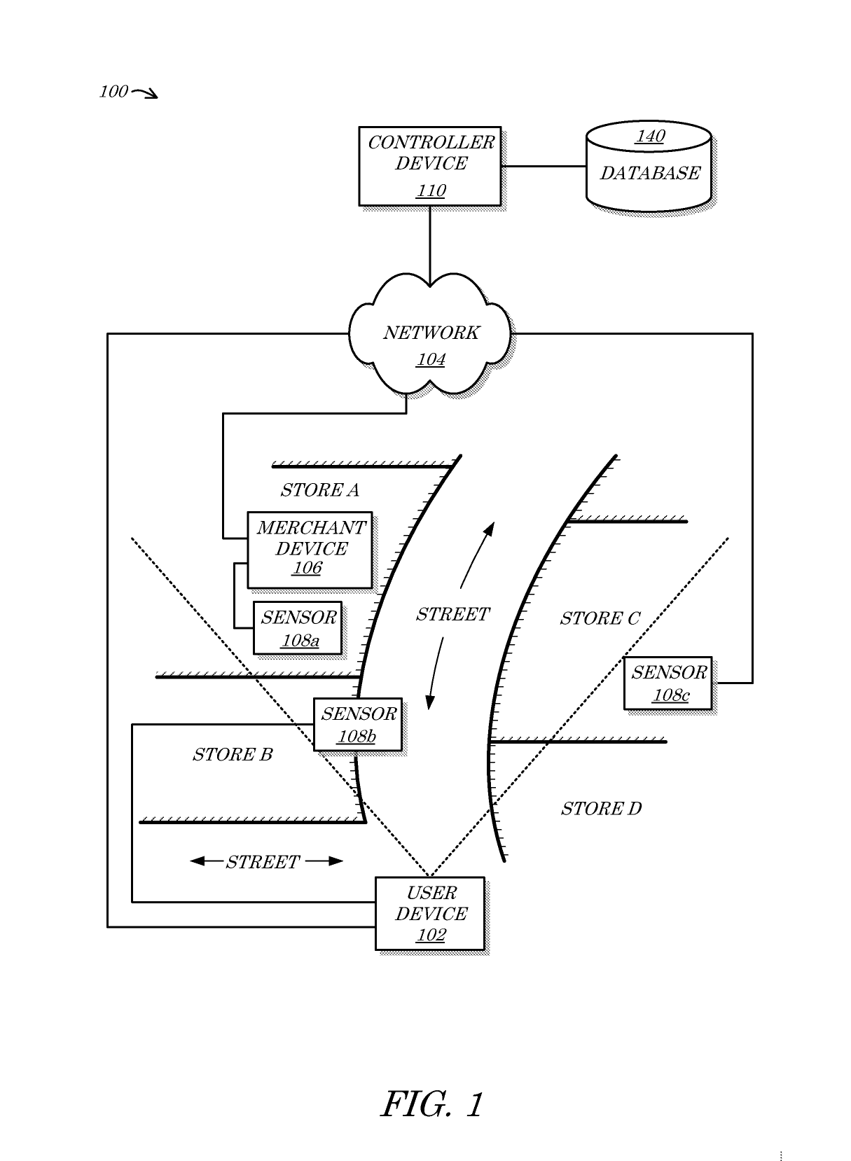

Referring initially to FIG. 1, a block diagram of a system 100 according to some embodiments is shown. In some embodiments, the system 100 may comprise a user device 102, a network 104, a merchant device 106, one or more sensor devices 108a-c, a controller device 110, and/or a database 140. As depicted in FIG. 1, any or all of the devices 102, 106, 108a-c, 110, 140 (or any combinations thereof) may be in communication via the network 104. In some embodiments, the system 100 may be utilized provide AR applications via the user device 102. The controller device 110 may, for example, interface with one or more of the user device 102, the merchant device 106, the sensors 108a-c, and/or the database 140 to send data and/or instructions to the user device 102 (and/or the merchant device 106) to facilitate functionality of an AR application via the user device 102, in accordance with embodiments described herein.

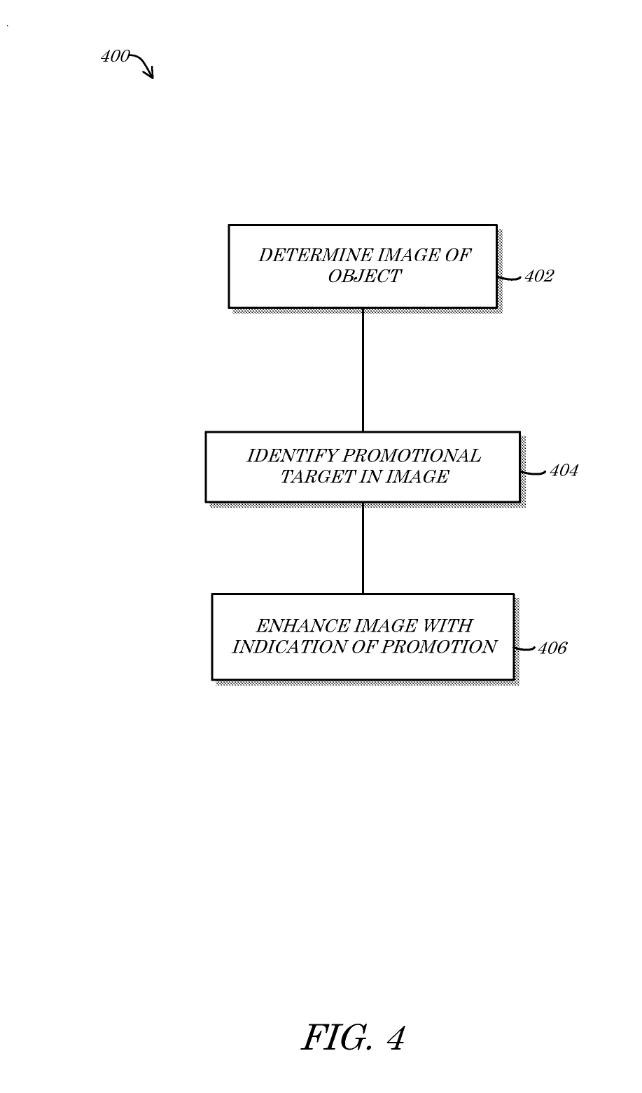

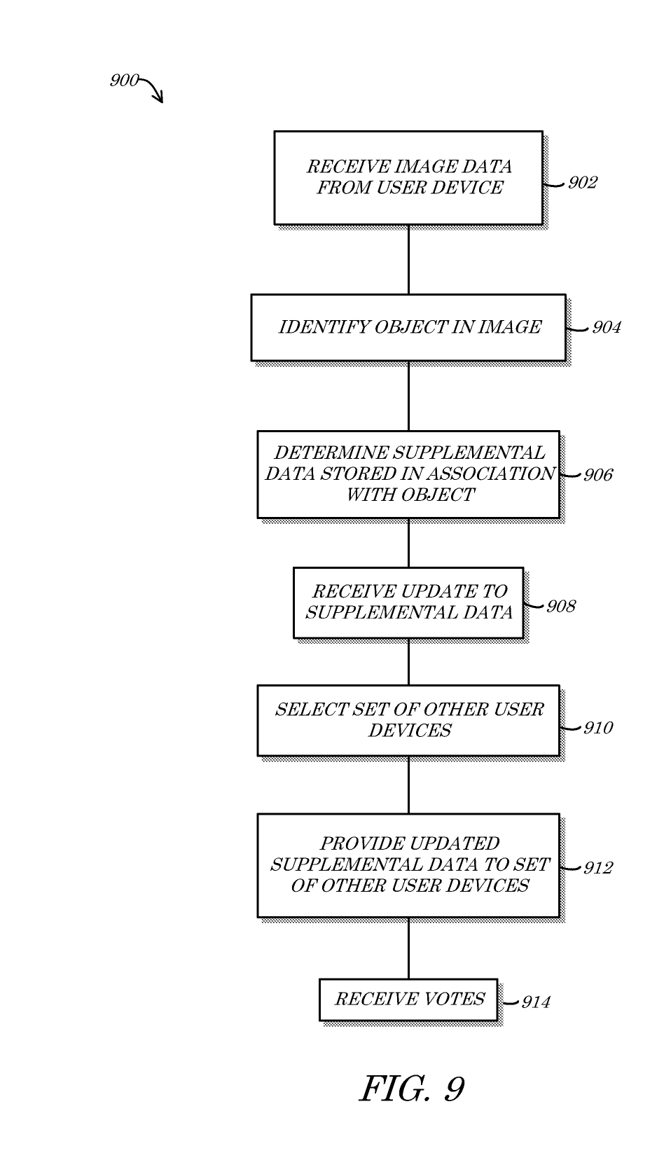

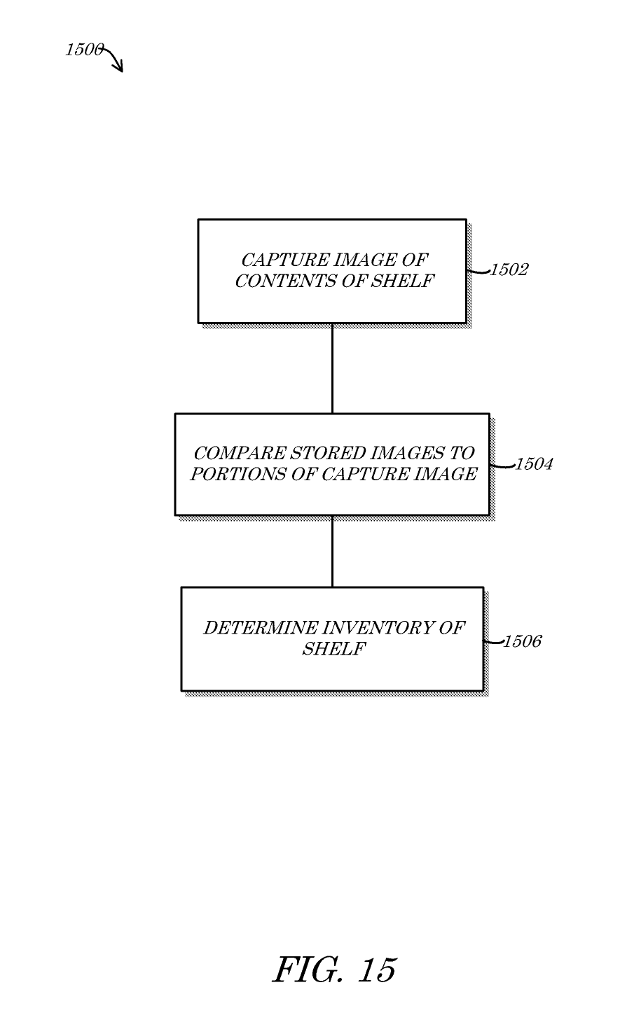

Fewer or more components 102, 104, 106, 108a-c, 110, 140 and/or various configurations of the depicted components 102, 104, 106, 108a-c, 110, 140 may be included in the system 100 without deviating from the scope of embodiments described herein. In some embodiments, the components 102, 104, 106, 108a-c, 110, 140 may be similar in configuration and/or functionality to similarly named and/or numbered components as described herein. In some embodiments, the system 100 (and/or portion thereof) may comprise an ARR program, system, and/or platform programmed and/or otherwise configured to execute, conduct, and/or facilitate the methods 400, 900, 1500 of FIG. 4, FIG. 9, and/or FIG. 15, and/or portions or combinations thereof, described herein.

The user device 102, in some embodiments, may comprise any type or configuration of computing, mobile electronic, network, user, and/or communication device that is or become known or practicable. The user device 102 may, for example, comprise one or more Personal Computer (PC) devices, tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. According to some embodiments, the user device 102 may comprise a wearable and/or implanted device configured for AR applications such as Google® Glass™ manufactured by Google®, Inc. of Mountain View, Calif. and/or newly-introduced “smart” contact lenses.

In some embodiments, the user device 102 may comprise a device owned and/or operated by one or more users such as consumers, customers, account holders, etc. According to some embodiments, the user device 102 may communicate with the controller device 110 via the network 104, such as to facilitate implementation of ARR applications as described herein. According to some embodiments, the user device 102 may comprise a camera and/or image capture device and/or sensor (not explicitly shown in FIG. 1) that comprises a field-of-view as depicted by the dashed lines in FIG. 1. The user device 102 may be utilized, for example, to capture an image (e.g., still, video, and/or real-time) of a streetscape (i.e., the streets and stores depicted in FIG. 1).

In some embodiments, the user device 102 may transmit image data descriptive of the streetscape (and/or other location) to the controller device 110 (e.g., via the network 104). The controller device 110 may process and/or analyze the image data to determine desired enhancements to the image data. Based on the contents of the image data (and/or the location of the user device 102), for example, the controller device 110 may query the database 140 to determine any applicable promotions such as retail product and/or service discounts, awards, incentives, and/or other benefits. According to some embodiments, the controller device 110 may transmit ARR data (e.g., image enhancement data associated with the identified promotion) to the user device 102. The user device 102 may utilize the image enhancement data to provide an ARR application to a user of the user device 102, as described herein.

The network 104 may, according to some embodiments, comprise a Local Area Network (LAN; wireless and/or wired), cellular telephone, Bluetooth®, Near Field Communication (NFC), and/or Radio Frequency (RF) network with communication links between the controller device 110, the user device 102, the merchant device 106, the sensors 108a-c, and/or the database 140. In some embodiments, the network 104 may comprise direct communications links between any or all of the components 102, 106, 108a-c, 110, 140 of the system 100. The user device 102 may, for example, be directly interfaced or connected to one or more of the merchant device 106, the sensor devices 108a-c, the controller device 110, and/or the database 140, via one or more wires, cables, wireless links, and/or other network components, such network components (e.g., communication links) comprising portions of the network 104. In some embodiments, the network 104 may comprise one or many other links or network components other than those depicted in FIG. 1. The user device 102 may, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102, 106, 108a-c, 110, 140 of the system 100. The network 104 may comprise one or more cellular telephone networks with communication links between the user device 102 and the controller device 110, for example, and/or may comprise the Internet, with communication links between the controller device 110 and the merchant device 106, sensors 108a-c, and/or database 140, for example.

The merchant device 106, in some embodiments, may comprise any type or configuration a computerized processing device such as a PC, laptop computer, computer server, database system, and/or other electronic device, devices, or any combination thereof. In some embodiments, the merchant device 106 may be owned and/or operated by a third-party (i.e., an entity different than any entity owning and/or operating either the user device 102 or the controller device 110. The merchant device 106 may, for example, be owned and/or operated by a merchant (owner/operator/lessee) of the depicted “STORE A” in FIG. 1. In some embodiments, the merchant device 106 may comprise a Point-Of-Sale (POS) controller and/or terminal of the “STORE A”. In some embodiments, the merchant device 106 may comprise a plurality of devices and/or may be associated with a plurality of merchant, retailer, manufacturer, and/or other third-party entities.

In some embodiments, the controller device 110 may comprise an electronic and/or computerized controller device such as a computer server communicatively coupled to interface with the user device 102, the merchant device 106, the sensors, 108a-c, and/or the database 140 (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user device 102, the third-party device 106, the sensors 108a-c, and/or the database 140. The controller device 110 may also or alternatively comprise a plurality of electronic processing devices located at one or more various sites and/or locations.

According to some embodiments, the sensor devices 108a-c may comprise any number, configuration, and/or types of devices operable, coupled, and/or configured to sense and/or communicate with the user device 102 (and/or with each other). In some embodiments, one or more of the sensor devices 108a-c may comprise a Bluetooth® Low Energy (BLE) device such as an iBeacon® device manufactured by Apple®, Inc. of Cupertino, Calif. The sensor devices 108a-c may, for example, sense the presence and/or proximity of the user device 102 and/or may push notifications and/or data to the user device 102. A first sensor device 108a may, in some embodiments, detect the user device 102 in proximity to the “STORE A” and/or may communicate such location information of the user device 102 to the merchant device 106. In some embodiments, the first sensor device 108a may detect and/or measure an actual distance between the user device 102 and the first sensor device 108a (e.g., a first distance) and/or may provide such measurement data to the merchant device 106 and/or the controller device 110. The merchant device 106 may utilize the detection of the user device 102 (and/or the distance measurement data) to push data to the user device 102 via the first sensor 108a (e.g., the user device 102 may receive data from the first sensor device 108a). The merchant device 106 may, for example, instruct the first sensor device 108a to transmit an offer and/or promotion to the user device 102. According to some embodiments, the merchant device 106 may send the location information of the user device 102 to the controller device 110 and/or may query the controller device 110 for an appropriate promotion and/or other content to push to the “STORE A”-proximate user device 102.

In some embodiments, the promotional information transmitted to the user device 102 may comprise ARR data. The ARR data may, for example, comprise instructions and/or data that cause an ARR application operating on and/or via the user device 102 to operate in a particular manner. The ARR data may, for example, comprise data and/or instructions that cause the user device 102 to superimpose and/or otherwise integrate graphics and/or other virtual media into an image of the streetscape, as described herein. In some embodiments, data from the sensors 108a-c and/or the user device 102 may be utilized to determine a location of the user device 102 with respect to a business and/or location that is not equipped with a sensor device 108a-c—such as the depicted “STORE D”. In such a manner, for example, business that have not implemented sensor device 108a-c may still benefit from location-based push promotions or competitor businesses that have implemented and/or installed sensor devices 108a-c (such as the depicted “STORE C” and/or “STORE B”) may utilize the system 100 to entice customers (e.g., users of the user device 102) away from “STORE D”—such as by sending promotions (e.g., discounts/offers) to the user device 102 as the user device approaches (or appears headed for—e.g., computed trajectory) the competitor's “STORE D”. In such a manner, discount offers and/or marketing budget may be reserved for consumers likely to patron a competitor as opposed to being generally marketed and/or spent (e.g., which is, to some extent, wasted on consumers for which it was not required, such as customers that were not en-route to patronize the competitor's store).

According to some embodiments, data from the sensor device 108a-c may be aggregated, acquired, analyzed, and/or otherwise processed by the controller device 110. The controller device 110 may utilize location and/or distance measurement data from the sensor devices 108a-c and/or the user device 102, for example, to determine a precise location of the user device 102. The location data may be utilized, for example, to triangulate the location of the user device 102, such as by comparing sensing and/or distance measurement data from a plurality of the sensor devices 108a-c and/or the user device 102. In some embodiments, the location and/or distance measurement data may be compared to and/or incorporate with image data received from the user device 102 to determine a location and/or orientation of the user device 102. Similarly, data from the sensor devices 108a-c and/or the user device 102 (location data, accelerometer data, and/or image data) may be monitored for changes to determine a direction of travel, speed, and/or likely destination of the user device 102 (e.g., and accordingly of the user themselves). Any or all of such data may be utilized as described herein to define communications with the user device 102 and/or to define ARR data provided to the user device 102.

In some embodiments, the controller device 110 may store and/or execute specially programmed instructions to operate in accordance with embodiments described herein. The controller device 110 may, for example, execute one or more programs that facilitate the utilization and/or implementation of ARR applications via the user device 102. According to some embodiments, the controller device 110 may comprise a computerized processing device such as a PC, laptop computer, computer server, and/or other electronic device to manage and/or facilitate input, output, transactions and/or communications regarding the user device 102. The controller device 110 may be programmed and/or otherwise utilized, for example, to (i) determine user and/or user device 102 locations (e.g., by processing data from the user device 102 and/or one or more of the sensor devices 108a-c), (ii) identify, analyze, parse, enhance, and/or process images received from the user device 102, (iii) determine (e.g., by accessing the merchant device 106 and/or the database 140) promotions to be output to and/or via the user device 102, and/or (iv) transmit transaction signals to either or both of the user device 102 and the merchant device 106 to effectuate and/or facilitate a purchase transaction in accordance with an applicable promotion (e.g., in accordance with embodiments described herein).

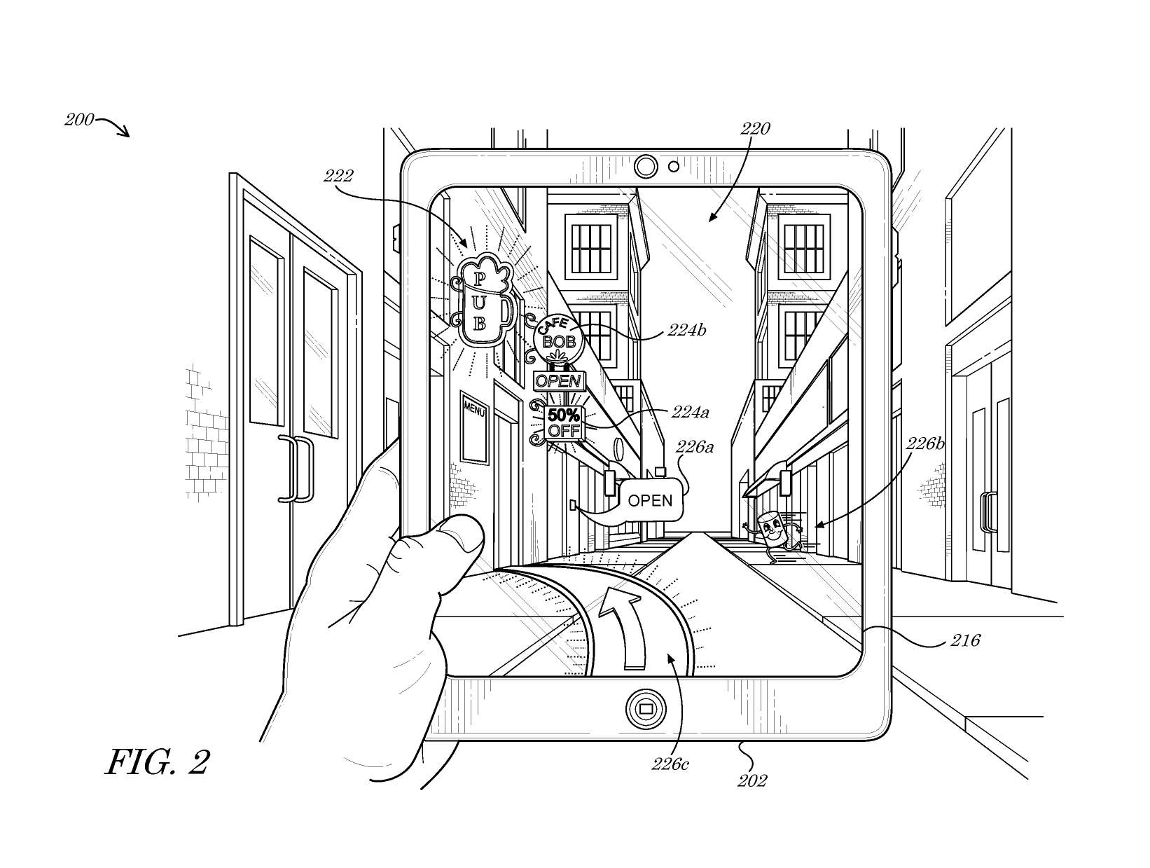

Turning now to FIG. 2, a perspective diagram of an example system 200 according to some embodiments is shown. In some embodiments, the system 200 may comprise user device 202 having a display device 216 that outputs an interface 220. The interface 220 may, for example, comprise output from an ARR application that is programmed to enhance real-world images with augmented and/or supplemental content. As depicted, for example, the interface 220 (via the display device 216) displays an image of a streetscape (such as the streetscape depicted in FIG. 1) in which the user device 202 is located. The user device 202 may, in some embodiments, comprise a camera (not shown in FIG. 2) that captures an image in the direction opposite of the output of the interface 220 (e.g., oriented opposite to the display device 216 that outputs the interface 220), allowing a user (not fully and/or explicitly shown in FIG. 2) to utilize the user device 202 as a virtual reality ‘frame’ or lens through which the streetscape (or other real-world location) may be viewed. The interface 220 may comprise, as depicted for example, a real-time image of the streetscape behind the user device 202 being held up by the user.

In some embodiments, the interface 220 may be augmented with data supplemental to the real-time, real-world image data received by the camera and output via the display device 216. The interface 220 may comprise, for example, a highlighting 222 of one or more objects or features in the real-time image. As depicted, for example, the highlighting 222 alters the portion of the real-time image corresponding to a sign for a particular business in front and to the left of the user/user device 202. In such a manner, for example, the user's attention may be drawn to the business—e.g., a “virtual neon sign”. According to some embodiments, the highlighting 222 may be implemented based on data related to the business. The business may pay a fee to have the highlighting 222 applied to the interface 220, for example, and/or the highlighting 222 may be applied to businesses which meet or exceed certain ratings, review levels, and/or other thresholds. In some embodiments, the highlighting 222 may be applied based on user preferences, characteristics, and/or search criteria. The user may be an English-speaking tourist and the streetscape may be a location in a non-English speaking country, for example, and the highlighting 222 may be implemented and/or associated with the designated business establishment because it is known (e.g., stored in a database) that the business offers an English-language menu and/or that English is spoken in the establishment (and/or that English-speaking patrons frequent the establishment).

According to some embodiments, the interface 220 may comprise other and/or additional enhancements to the real-time and/or real-world image output by the display device 216. The interface 220 may comprise, for example, one or more image modifications 224a-b. A first image modification 224a may comprise, in some embodiments, an overlay and/or superimposed graphic (and/or other media) that enhances and/or replaces a particular portion of the image such as the square overhead signage on the left side of the street in the streetscape as depicted in FIG. 2. While the original and/or actual sign may simply identify the associated store, for example, the first image modification 224a may replace the real-world sign in the interface 220 with an offer, promotion, and/or other supplemental and/or dynamic data. As depicted, for example, the first image modification 224a may replace the real-world sign with an offer for “50% OFF”. According to some embodiments, the first image modification 224a may replace the actual real-world text of the sign with a translated version of the text, such as to facilitate the user's understanding of the streetscape in the case that the local signage is printed in a different language.

In some embodiments, the second image modification 224b may replace and/or overlay a portion of a sign and/or other image feature such as to provide image customization. As depicted, for example, the second image modification 224b may virtually alter the name of a business establishment to customize and/or personalize the name to the user of the user device 202—e.g., “Café Mooy” is changed to “Café Bob”, such as to customize the name for a user named Bob. Similar modifications may be superimposed on the image via the interface 220 to incorporate other user characteristics, likes, and/or preferences such as by inserting the name or logo of a user's favorite sports team and the like (not depicted in FIG. 2).

In some embodiments, the interface 220 may comprise one or more image enhancements 226a-c. A first image enhancement 226a may, for example, comprise an informational bubble (or other superimposed, overlaid, and/or incorporated text, graphic, and/or other media) that notifies the user that a closed storefront will be opening at a particular time (and/or otherwise advising the user regarding store hours such as a message that a store will be closing in a few minutes). A second image enhancement 226b may, according to some embodiments, comprise an animation of a product. The second image enhancement 226b may, as depicted for example, comprise an animated version of a product peeking out of a store window or door, such as to draw the user's attention to the particular store and/or to inform he user that a particular type of product is available and/or for sale at the particular store. In some embodiments, the animation may include movement of the product (or other animated object) to or from a particular portion of the image. The animated product may appear and ‘run’ into a particular store, for example, suggesting that the user follow the animated product. Similarly, the animated product may appear at or near a competitor's store in the image and then move through the image to lead the user away from the competitor's establishment.

According to some embodiments, a third image enhancement 226c may comprise a virtual walkway, line, bridge, track, and/or other directional feature such as an animated ‘yellow brick road’ leading the user to a particular location in the image. In some embodiments, any or all of the highlighting 222, the image modifications 224a-b, and/or the image enhancements 226a-c may be updated and/or modified (i) as the user and/or user device 202 move, (ii) as time passes (e.g., the interface 220 may change based on time windows and/or triggers), and/or (iii) based on information received from other devices (such as the merchant device 106, sensor devices 108a-c, and/or controller device 110 of FIG. 1). In some embodiments, any or all of the highlighting 222, the image modifications 224a-b, and/or the image enhancements 226a-c may be defined and/or implemented based on (i) the location of the user and/or user device 202, (ii) characteristics of the user and/or user device 202 (e.g., user preferences, demographics, etc.), and/or (iii) image artifacts identified in the image (e.g., brand logos, store names, etc.—as described herein).

Fewer or more components 202, 216, 220, 222, 224a-b, 226a-c and/or various configurations of the depicted components 202, 216, 220, 222, 224a-b, 226a-c may be included in the system 200 without deviating from the scope of embodiments described herein. In some embodiments, the components 202, 216, 220, 222, 224a-b, 226a-c may be similar in configuration and/or functionality to similarly named and/or numbered components as described herein. In some embodiments, the user device 202 (and/or portion thereof) may comprise an ARR program and/or platform programmed and/or otherwise configured to execute, conduct, and/or facilitate the methods 400, 900, 1500 of FIG. 4, FIG. 9, and/or FIG. 15, and/or portions or combinations thereof, described herein.

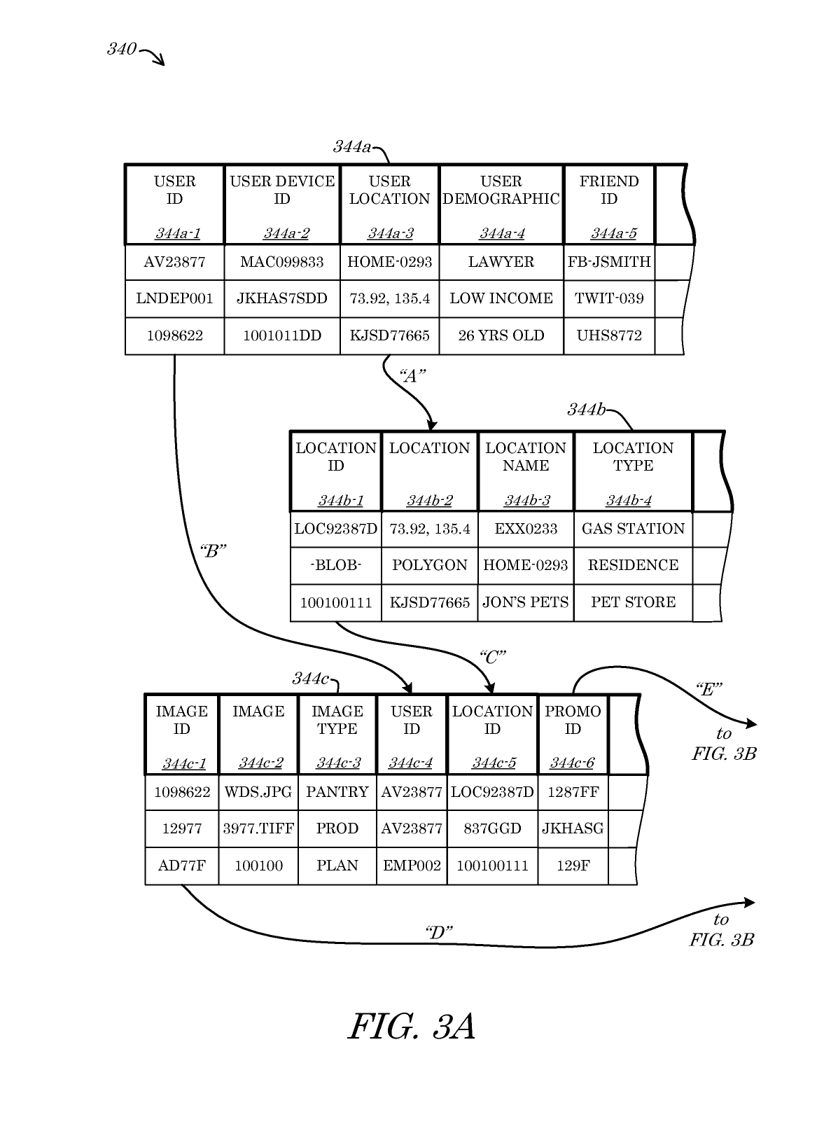

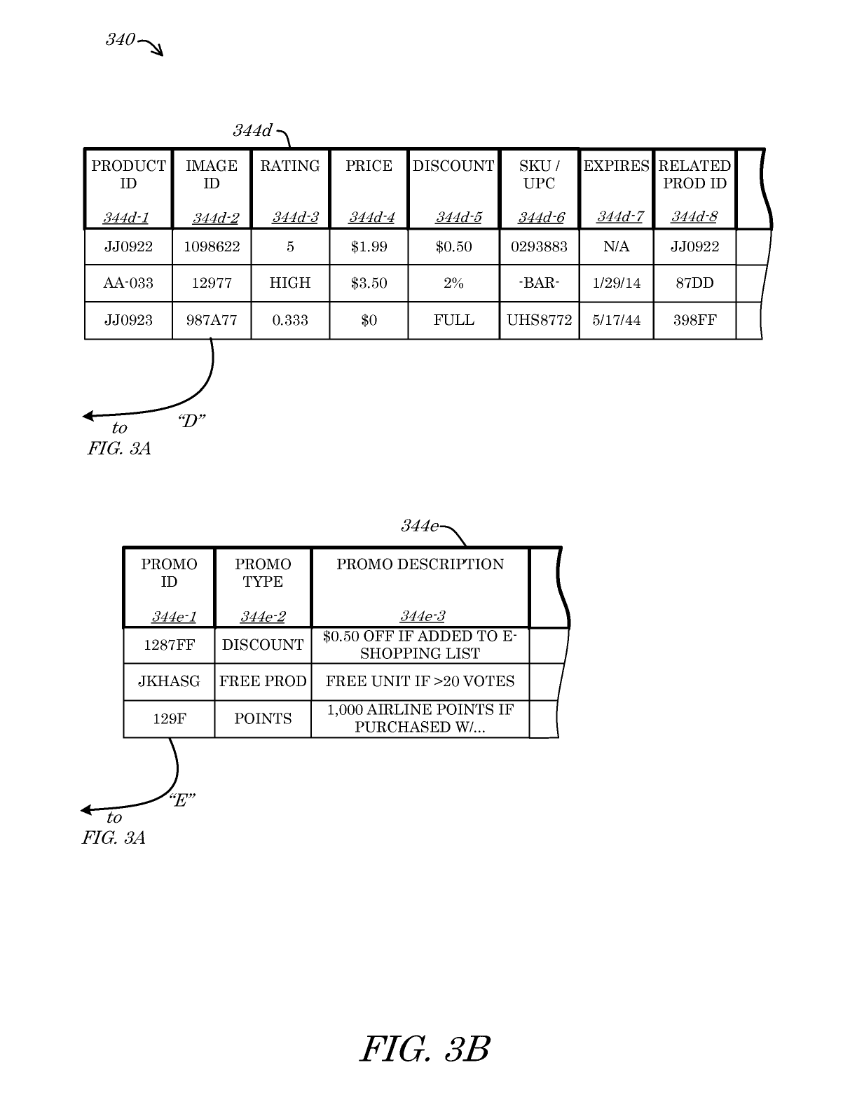

Referring to FIG. 3A and FIG. 3B, diagrams of an example data storage structure 340 according to some embodiments are shown. In some embodiments, the data storage structure 340 may comprise a plurality of data tables such as a user table 344a, a location table 344b, an image table 344c, a product table 344d, and/or a promotion table 344e. The data tables 344a-e may, for example, be utilized to store information that is utilized to provide ARR functionality to a mobile electronic device as described herein.

The user table 344a of FIG. 3A may comprise, in accordance with some embodiments, a user IDentifier (ID) field 344a-1, a user device IDS field 344a-2, a user location field 344a-3, a user demographic field 344a-4, and/or a friend ID field 344a-5. Any or all of the ID fields 344a-1, 344a-2, 344a-5 may generally store any type of identifier that is or becomes desirable or practicable (e.g., a unique identifier, an alphanumeric identifier, and/or an encoded identifier). The user ID field 344a-1 may generally store an identifier of a user's account such as an e-mail address and/or other unique customer identifier. In some embodiments, the user location field 344a-3 may store data descriptive of a current, past, and/or projected or predicted future location of a user and/or user device associated with the data stored in the user ID field 344a-1 and/or in the user device ID field 344a-2, respectively. The user location field 344a-3 may store, for example, latitude and longitude coordinates, Global Positioning System (GPS) coordinates and/or data, signal triangulation data, location addresses and/or labels (e.g., “HOME”), etc. The user demographic field 344a-4 may store any type of information descriptive of a characteristic, preference, and/or demographic associated with the user such as the user's age, gender, occupation, financial data, residence and/or travel data, purchasing history, languages spoken, favorite stores, restaurant chains or types, etc. In some embodiments, the friend ID field 344a-5 may store an identifier of one or more other user's or individuals that have a relationship with the user. The friend ID field 344a-5 may store, for example, indications of one or more social network “friends” or contacts such as Microsoft® Outlook® contacts, Facebook® friends, Twitter® followers, etc.

The location table 344b of FIG. 3A may comprise, in accordance with some embodiments, a location ID field 344b-1, a location field 344b-2, a location name field 344b-3, and/or a location type field 344b-4. In some embodiments, the location field 344b-2 may store geo-location information such as latitude and longitude, GPS coordinate data, geographical feature data, structure data, roadway data, elevation data, distance data, etc. The location field 344b-2 may store, for example, data describing a real-world location of a particular store, building, business, product, and/or service location. In some embodiments, such as in the case that iBeacon® and or other fine-proximity devices (e.g., NFC communication devices, cameras, motion sensors, RFID tags, etc.) are utilized, the location field 344b-2 may store in-store and/or high-precision location data such as “Aisle 14, shelf 3”, or “Doritos® wall display”, or “three (3) feet from beacon #23472”. The location name field 344b-3 may store a descriptor and/or tag for a given location, coordinate, in-store location, etc., while the location type field 344b-4 may store an indicator of one or more categories and/or categorizations associated with the particular location.

The image table 344c of FIG. 3A may comprise, in some embodiments, an image ID field 344c-1, an image field 344c-2, an image type field 344c-3, a user ID field 344c-4, a location ID field 344c-5, and/or a promo ID field 344c-6. The image field 344c-2 may store, for example, an image file, image data, and/or a link to an image file and/or image data. In some embodiments, the image field 344c-2 may store data defining an image artifact such as a company logo, trademark, trade dress feature, etc. The image type field 344c-3 may store, in some embodiments, a descriptor of the image such as a location of the image, a type of location of the image, a type or quality of the image, an expected usage and/r purpose of the image, a tag associated with the image, etc.

The product table 344d of FIG. 3B may comprise, in some embodiments, a product ID field 344d-1, an image ID field 344d-2, a rating field 344d-3, a price field 344d-4, a discount field 344d-5, a SKU and/or UPC field 344d-6, an expires field 344d-7, and/or a related product ID field 344d-8. The rating field 344d-3 may store, for example, a qualitative or quantitative rating for a particular product, model number, and/or product feature, version, and/or functionality. The price field 344d-4 may store a value defining a price for the product such as a retail and/or manufacturer price, or a price associated with a particular retailer, store, business, and/or location. The discount field 344d-5 may store an indication of a discount or other benefit (e.g., a free warranty, free shipping/handling, etc.) associated with the product and the SKU/UPC field may store an indicator or value of a SKU and/or UPC assigned to the product. In the case that an entry in the product table 344d is descriptive of a particular unit of a product (e.g., a particular can of Pepsi® cola), the expires field 344d-7 may store an indication of an expiration and/or freshness date of the unit of product. According to some embodiments, the related product ID field 344d-8 may store an indication of an identifier (e.g., a database record identifier) of a product that is complimentary to the current product. While complimentary products such as shirts and neck ties are well known and often marketed for combined purchase discounts, other complimentary relationships that are novel are contemplated. The related product ID field 344d-8 may store, for example, a pointer to other products that may be utilized in conjunction with the current product to carry out instructions defined by a particular recipe or activity and/or are related by nature of being on the same grocery and/or other product purchase list. In some embodiments, the complimentary nature of the products may be defined based on nutritional and/or medical data. The data stored in the related product ID field 344d-8 may be utilized, for example, to suggest (or suggest against) a complimentary nutritional product to a user such as by suggesting that a spinach dish (e.g., a current product) by ordered along with a diary product (e.g., to reduce the negative texture implications of spinach eaten without diary), or conversely, to suggest that a diary product not be ordered so that the nutritional iron in the spinach dish be better absorbed into the user's body.

The promotion table 344e of FIG. 3B may comprise, in some embodiments, a promotion ID field 344e-1, a promotion type field 344e-2, and/or a promotion description field 344e-3. The promotion type field 344e-2 may store, in some embodiments, a description of a category, type, and/or categorization of the promotion and the promotion description field 344e-3 may store a description of the rules, guidelines, criteria, and/or values for various parameters defining the promotion.

In some embodiments, enhancements to images such as via ARR applications on mobile electronic devices may be defined by relationships established between two or more of the data tables 344a-e. As depicted in the example data storage structure 340, for example, a first relationship “A” may be established between the user table 344a and the location table 344b. In some embodiments (e.g., as depicted in FIG. 3A), the first relationship “A” may be defined by utilizing the user location field 344a-3 as a data key linking to the location field 344b-2. According to some embodiments, the first relationship “A” may comprise any type of data relationship that is or becomes desirable, such as a one-to-many, many-to-many, or many-to-one relationship. In the case that multiple users are likely to be present at the same location, the first relationship “A” may comprise a many-to-one relationship (e.g., many users per single retail location). In such a manner, for example, information specific to a user's location (and/or the location of the user's device) may be identified, accessed, and/or otherwise determined.

According to some embodiments, a second relationship “B” may be established between the user table 344a and the image table 344c. In some embodiments (e.g., as depicted in FIG. 3A), the second relationship “B” may be defined by utilizing the user ID field 344a-1 as a data key linking to the user ID field 344c-4. According to some embodiments, the second relationship “B” may comprise any type of data relationship that is or becomes desirable, such as a one-to-many, many-to-many, or many-to-one relationship. In the case that a single user is likely to be associated with multiple images (e.g., the user provides images of multiple products and/or multiple images of a given product and/or location), the second relationship “B” may comprise a one-to-many relationship (e.g., many images per single user). In such a manner, for example, multiple images may be associated with a given user and/or multiple users may be associated with a particular image (e.g., the later of which may be useful, for example, in product rating embodiments).

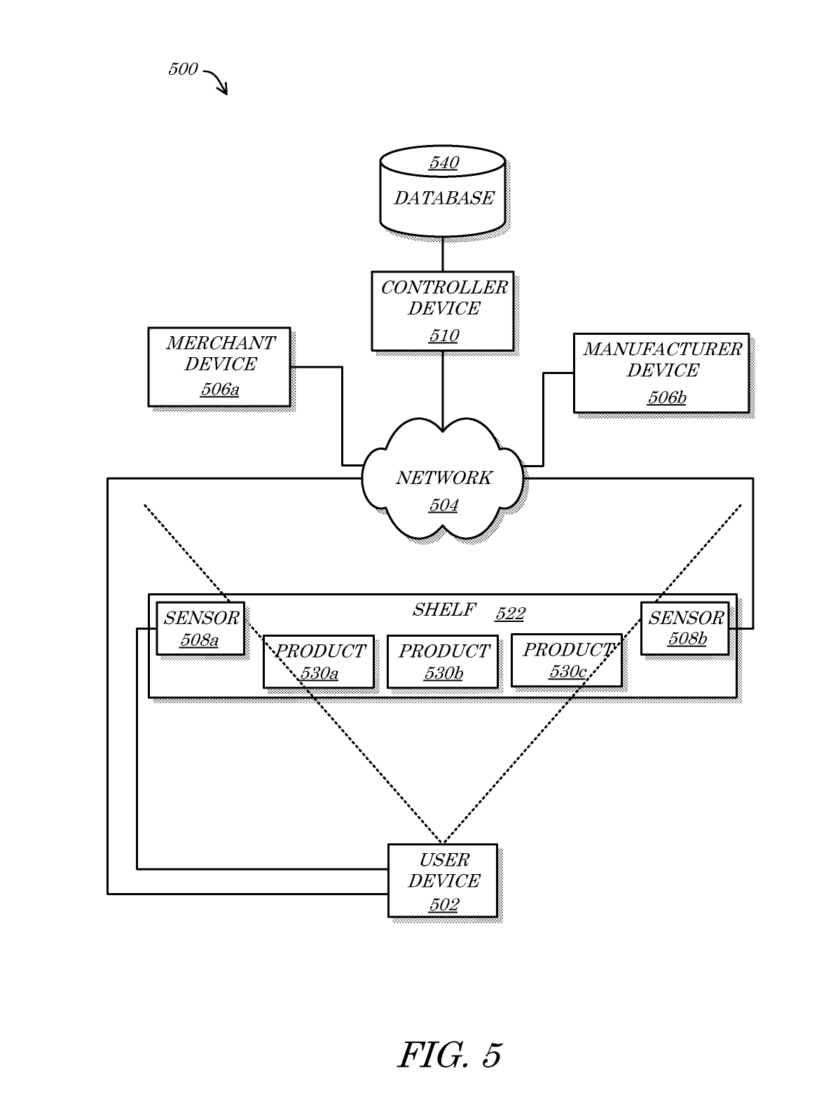

In some embodiments, a third relationship “C” may be established between the location table 344b and the image table 344c. In some embodiments (e.g., as depicted in FIG. 5A), the third relationship “C” may be defined by utilizing the location ID field 344b-1 as a data key linking to the location ID field 344c-5. According to some embodiments, the third relationship “C” may comprise any type of data relationship that is or becomes desirable, such as a one-to-many, many-to-many, or many-to-one relationship. In the case that a single location is likely to be associated with multiple images, the third relationship “C” may comprise a one-to-many relationship. In the case that an image is likely to be associated with multiple locations (e.g., an image of a product that is carried or otherwise moved from one place to another, such as an automobile), the third relationship “C” may comprise a one-to-many relationship.

In some embodiments, a fourth relationship “D” may be established between the image table 344c and the product table 344d (depicted as linking between FIG. 3A and FIG. 3B). In some embodiments (e.g., as depicted in FIG. 3A and FIG. 3B), the fourth relationship “D” may be defined by utilizing the image ID field 344c-1 as a data key linking to image ID field 344d-2. According to some embodiments, the fourth relationship “D” may comprise any type of data relationship that is or becomes desirable, such as a one-to-many, many-to-many, or many-to-one relationship. In the case that a product is likely to be associated with multiple images, the fourth relationship “D” may comprise a one-to-many relationship.

According to some embodiments, a fifth relationship “E” may be established between the image table 344c and the promotion table 344e (depicted as linking between FIG. 3A and FIG. 3B). In some embodiments (e.g., as depicted in FIG. 3A and FIG. 3B), the fifth relationship “E” may be defined by utilizing the promo ID field 344c-6 as a data key linking to the promo ID field 344e-1. According to some embodiments, the fifth relationship “E” may comprise any type of data relationship that is or becomes desirable, such as a one-to-many, many-to-many, or many-to-one relationship. In the case that promotions are likely to be associated with multiple images (and/or multiple products or locations), the fifth relationship “E” may comprise a one-to-many relationship.

Utilizing the various data relationships (“A”, “B”, “C”, “D”, and/or “E”), it may accordingly be possible to readily cross-reference a location, user (and/or user device), image, and/or product with various supplemental content such as promotional data. As described herein, for example, an image provided by a user may be analyzed to determine, based on image artifacts therein that correspond to stored image data, one or more applicable promotions. Similarly, user location and/or image location may be utilized to determine and/or govern which promotions a user is offered.

In some embodiments, fewer or more data fields than are shown may be associated with the data tables 344a-e. Only a portion of one or more databases and/or other data stores is necessarily shown in any of FIG. 3A and/or FIG. 3B, for example, and other database fields, columns, structures, orientations, quantities, and/or configurations may be utilized without deviating from the scope of some embodiments. According to some embodiments, such as in the case that supplemental content other than promotions is desired for provision to users and/or for ARR image modification, for example, such data may be stored in place of the promotional data of the promotion table 344e and/or in addition to the promotion table 344e. Further, the data shown in the various data fields is provided solely for exemplary and illustrative purposes and does not limit the scope of embodiments described herein.

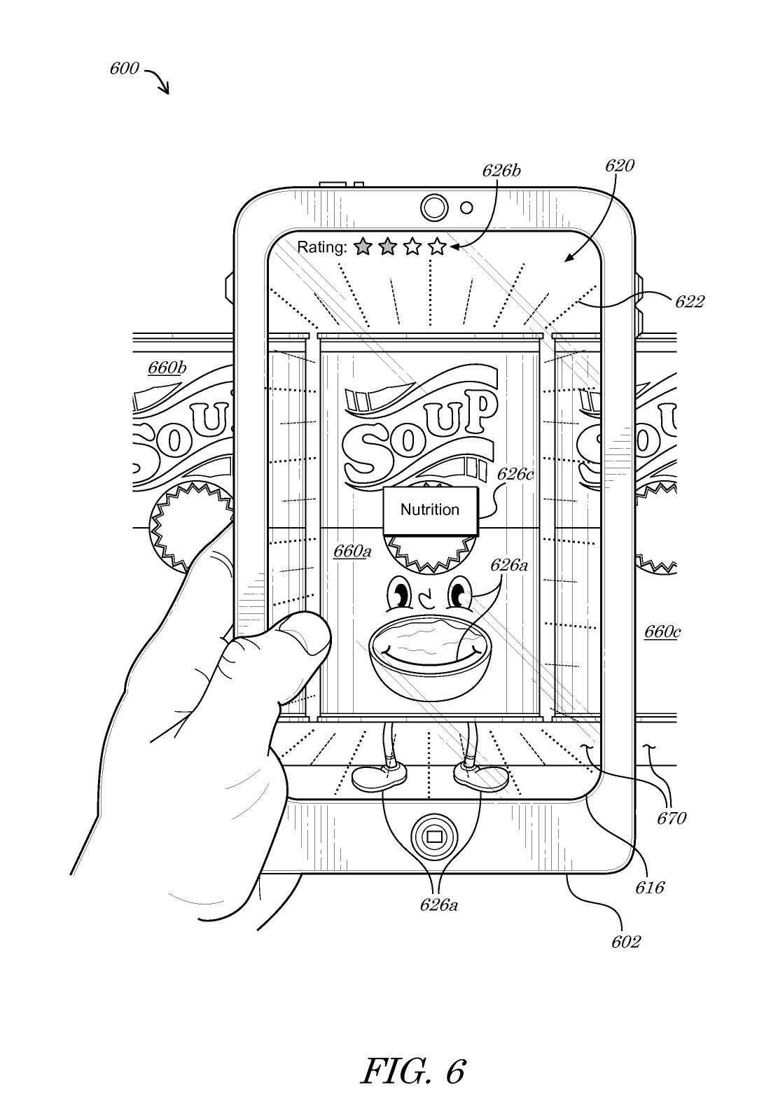

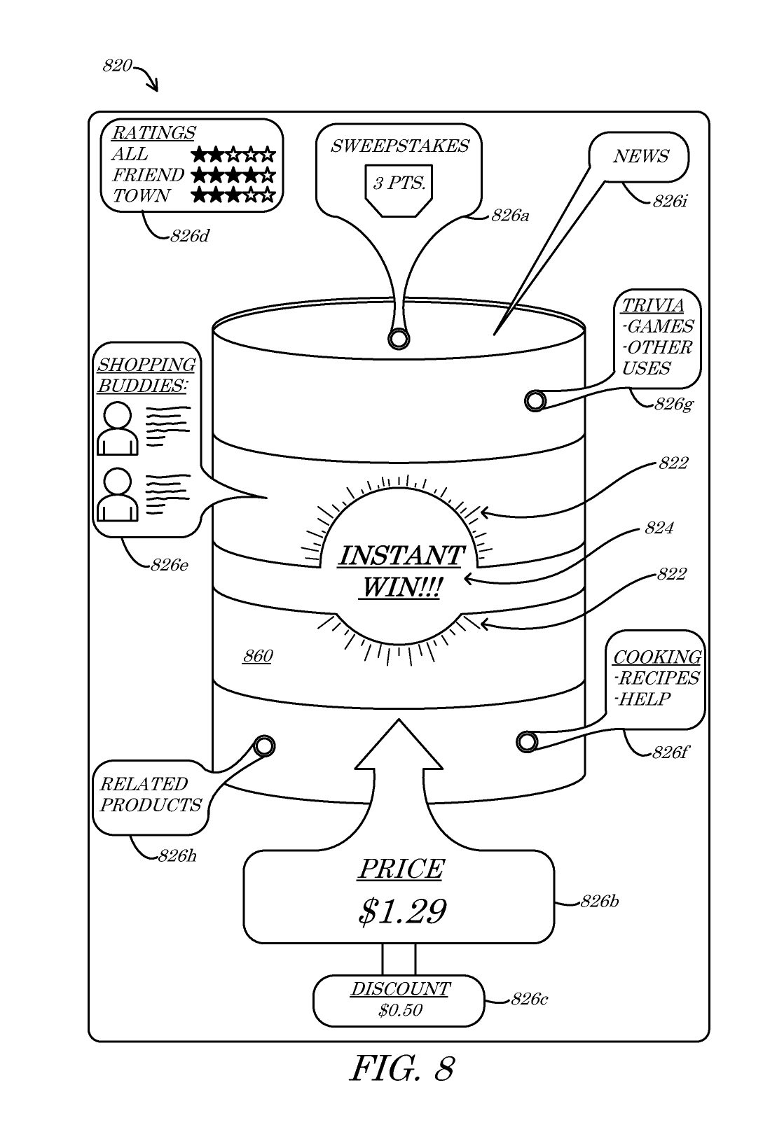

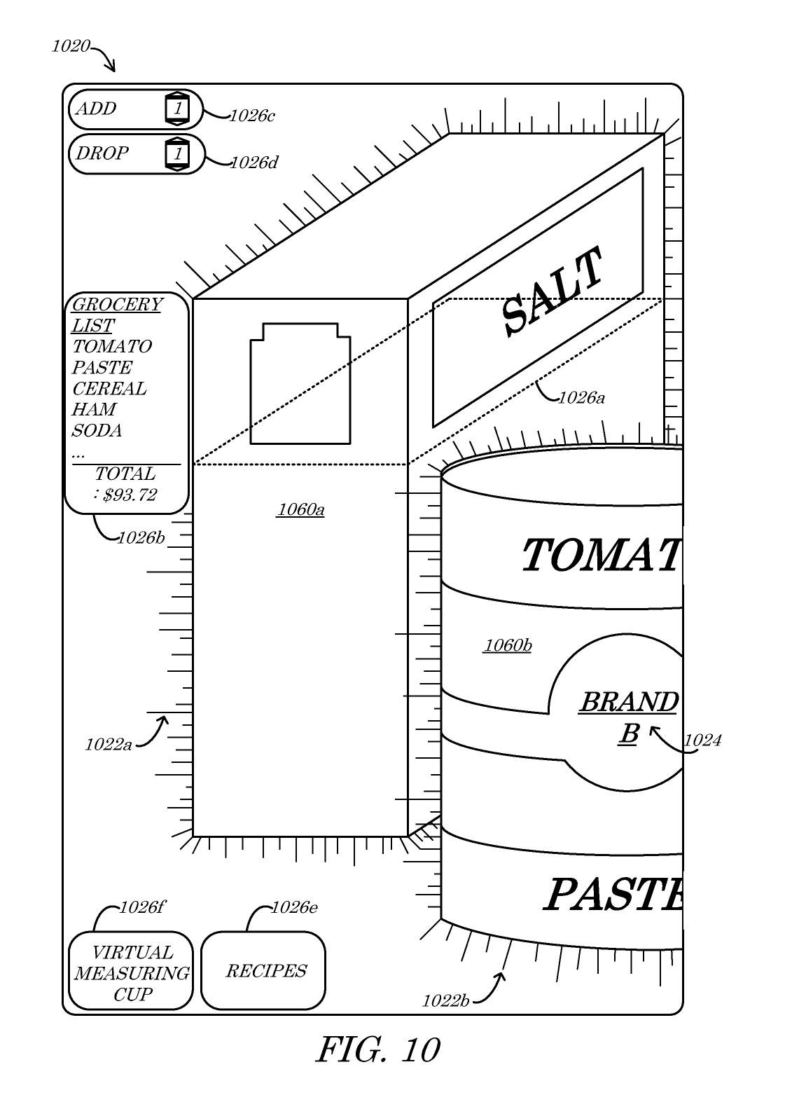

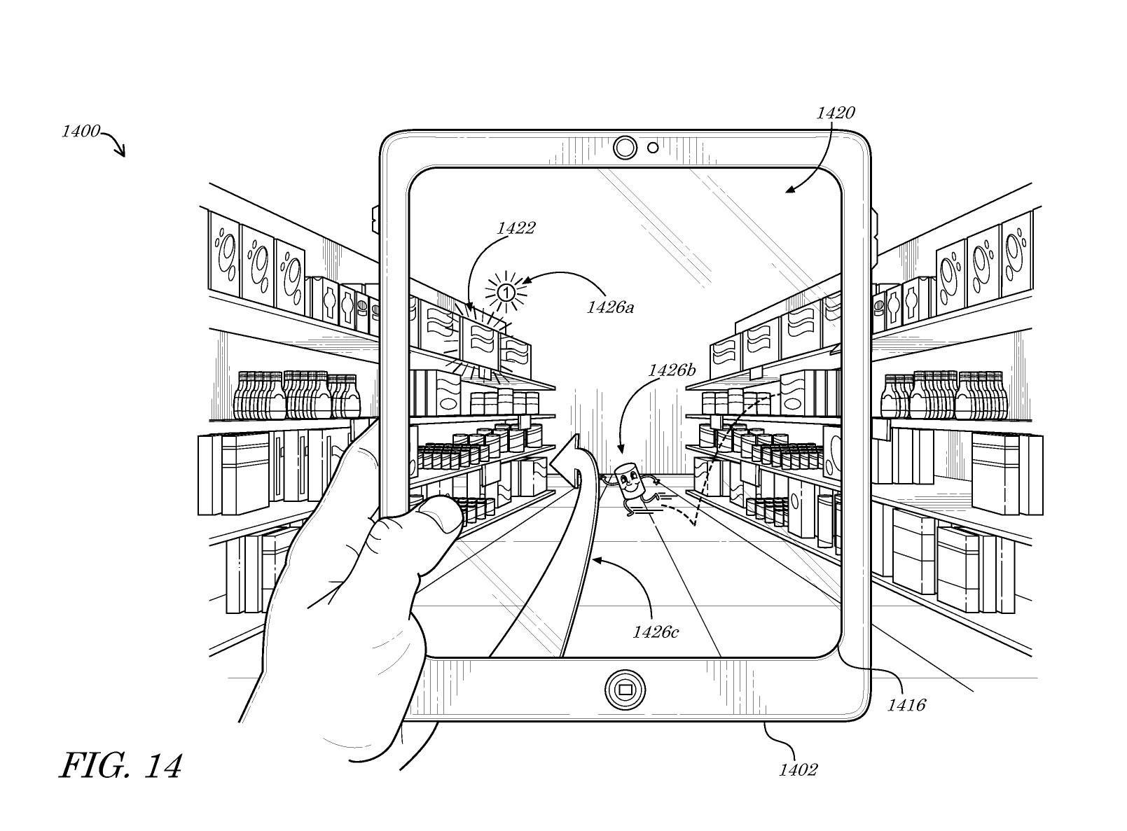

Turning now to FIG. 4, a flow diagram of a method 400 according to some embodiments is shown. In some embodiments, the method 400 may be implemented, facilitated, and/or performed by or otherwise associated with the system 100 of FIG. 1 herein (and/or portions thereof, such as the user device 102 and/or the controller device 110). In some embodiments, the method 400 may be implemented via a Graphical User Interface (GUI) such as one or more of the interfaces 220, 620, 820, 1020, 1320, 1420 of FIG. 2, FIG. 6, FIG. 8, FIG. 10, FIG. 13, and/or FIG. 14 herein.

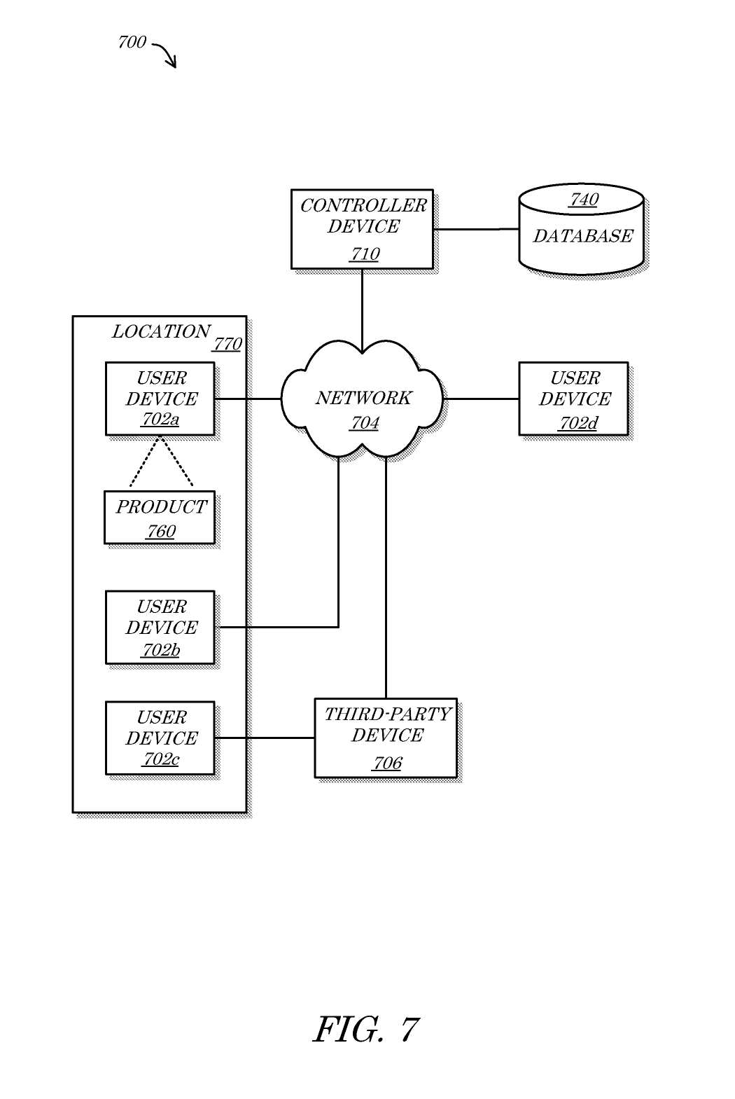

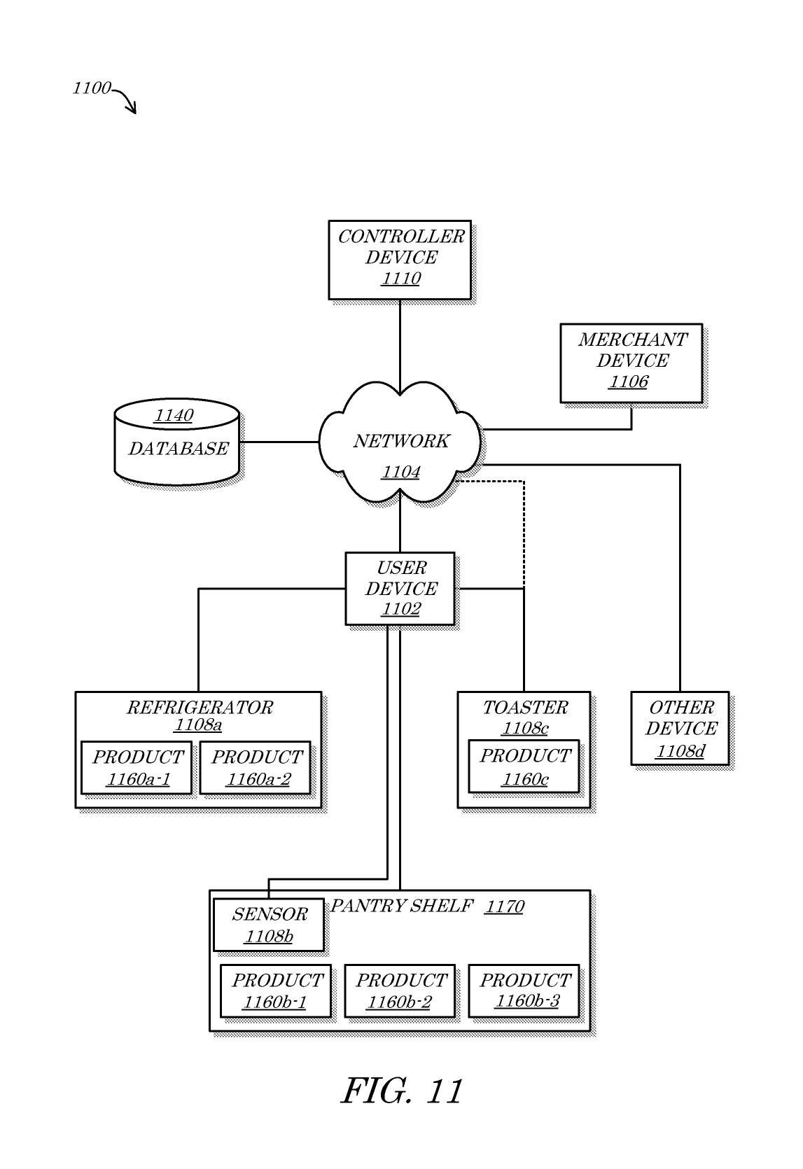

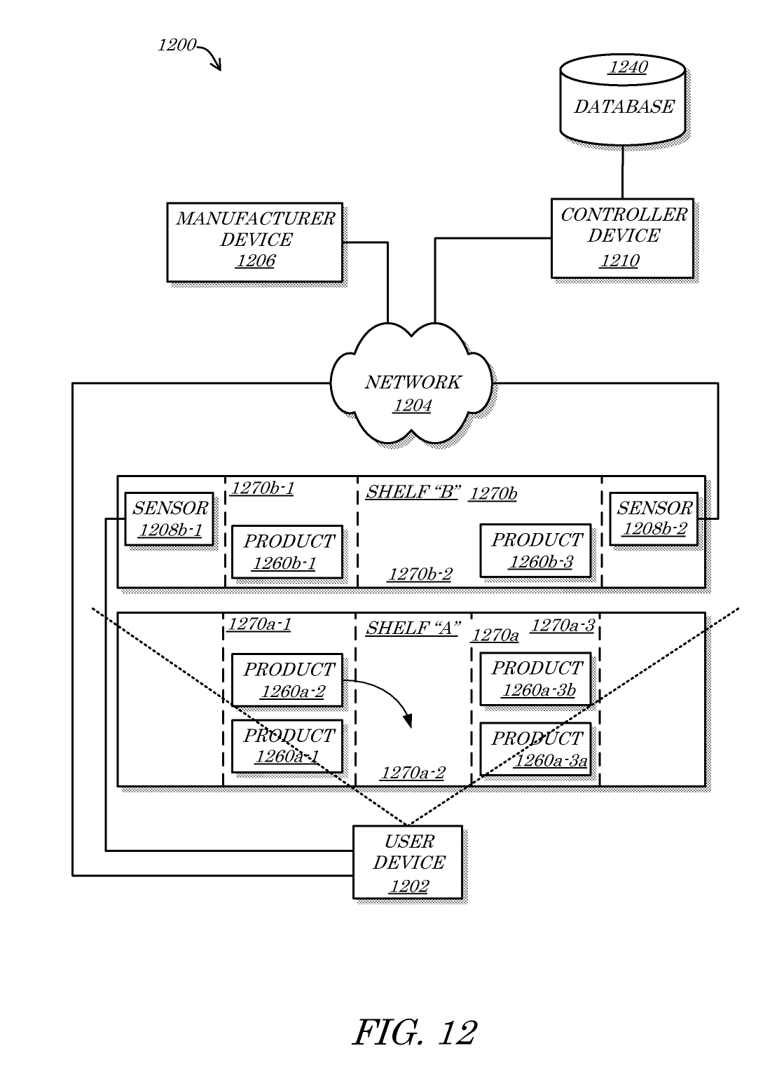

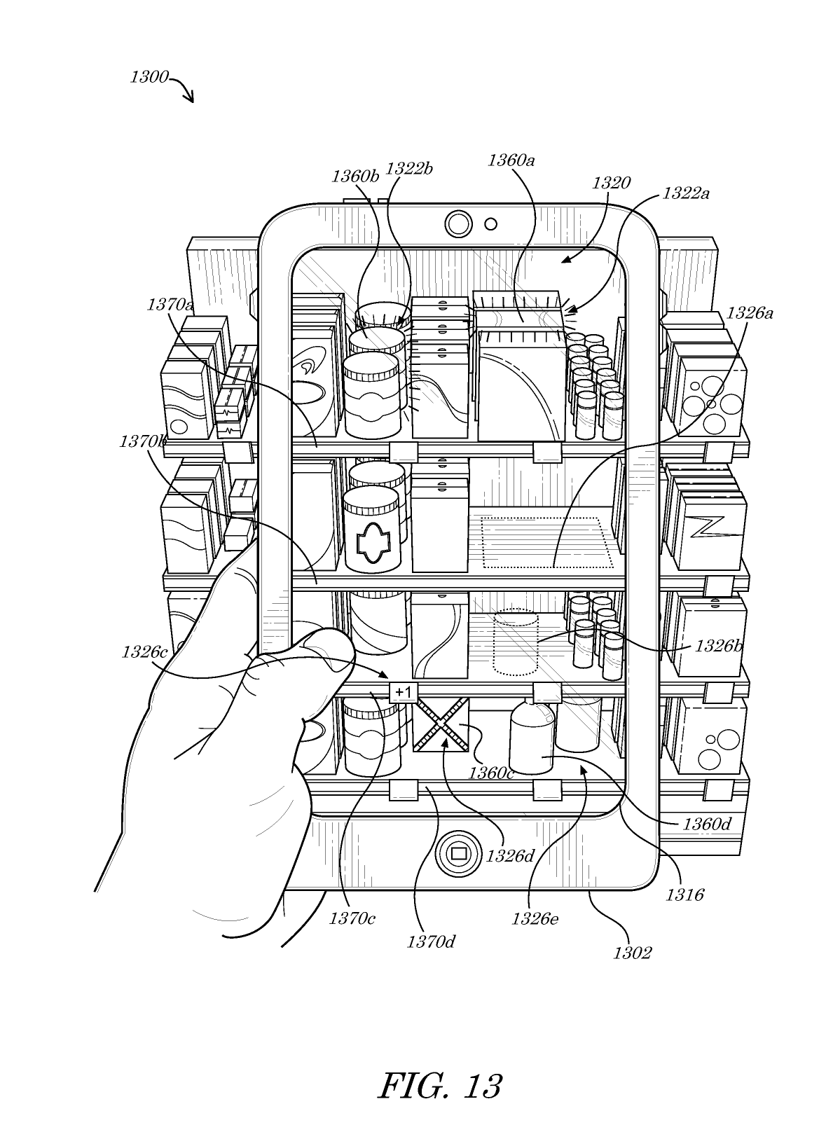

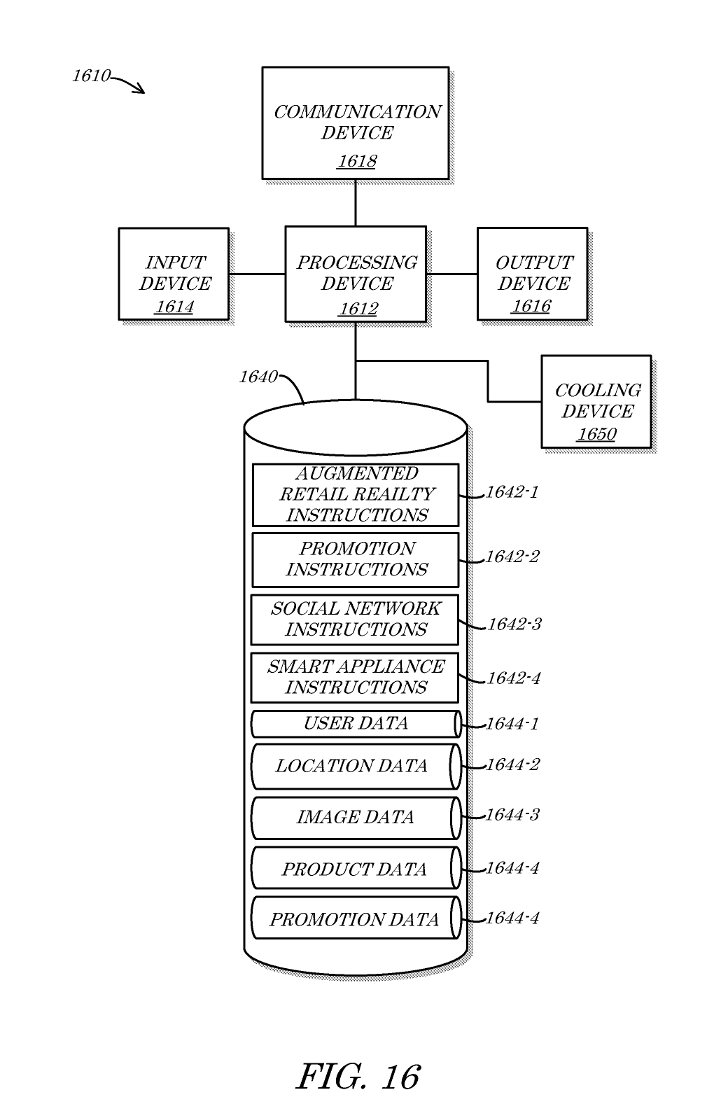

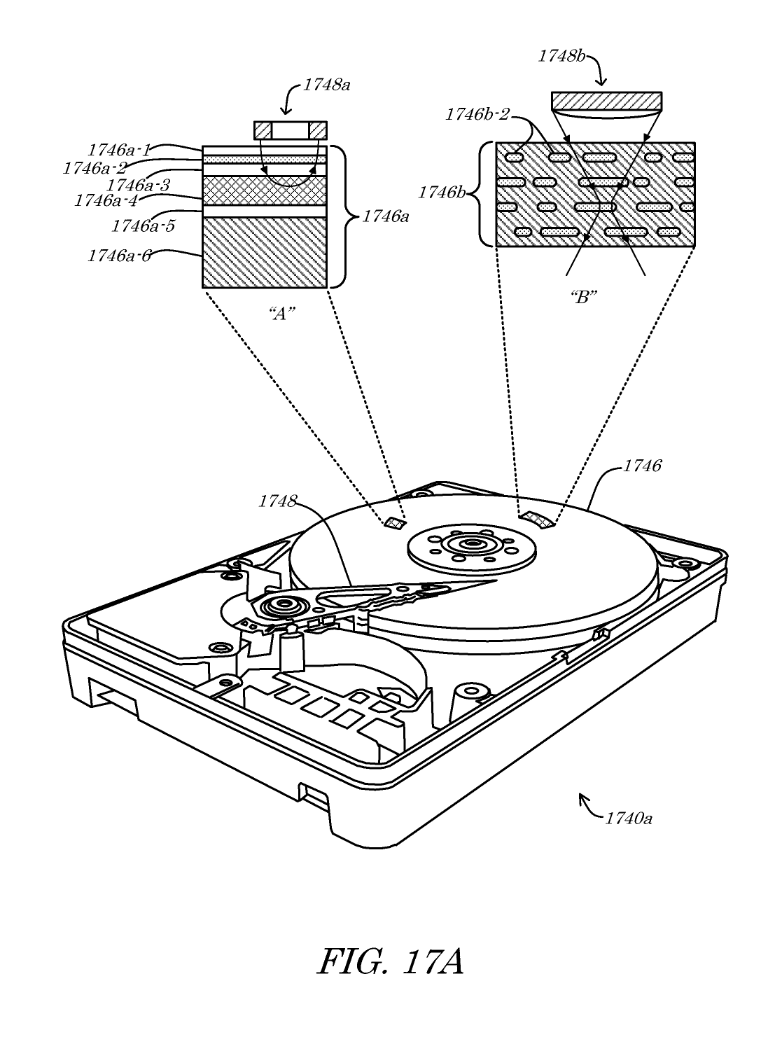

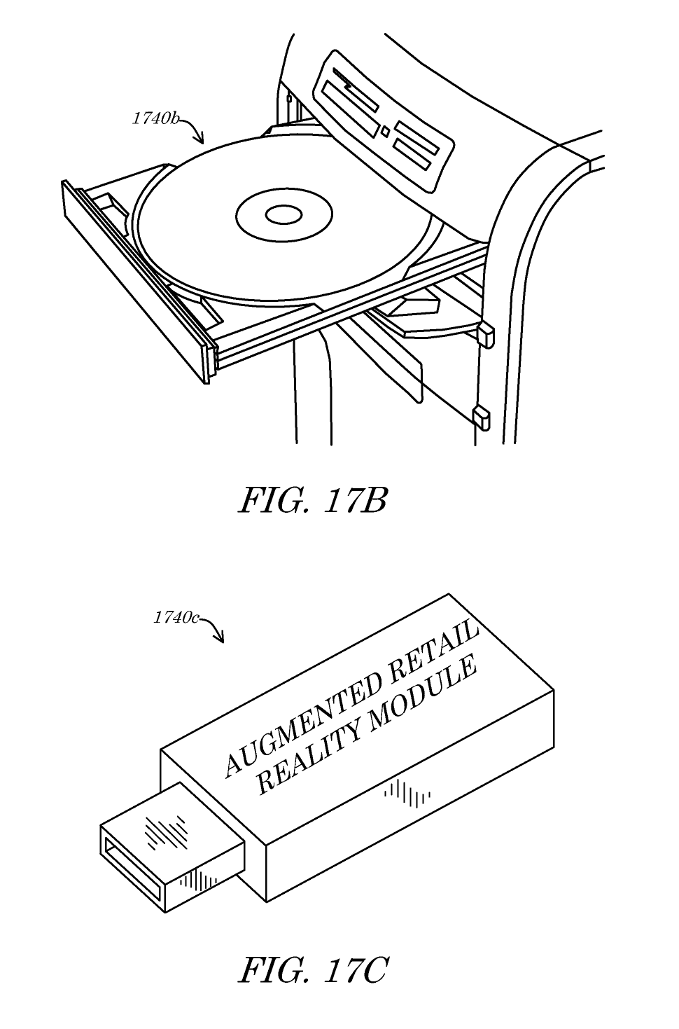

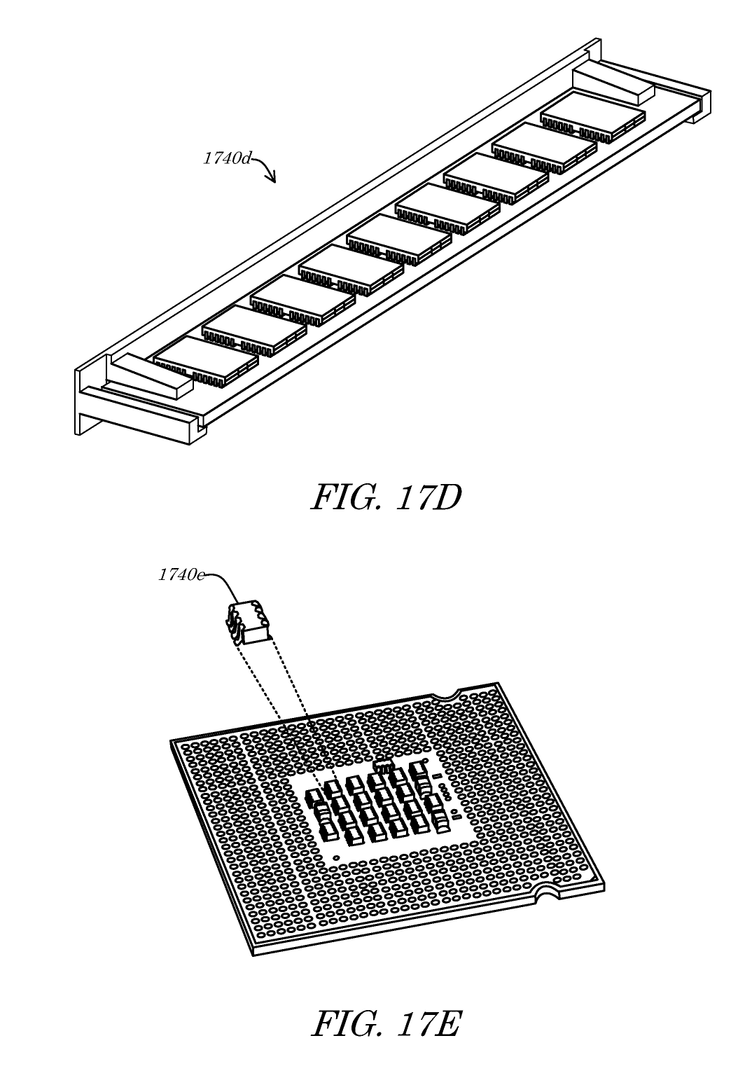

The process diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 140, 340, 540, 740, 1140, 1240, 1640, 1740a-e of FIG. 1, FIG. 3, FIG. 5, FIG. 7, FIG. 11, FIG. 12, FIG. 16, FIG. 17A, FIG. 17B, FIG. 17C, FIG. 17D, and/or FIG. 17E herein) may store thereon instructions that when executed by a machine (such as a computerized processor) result in performance according to any one or more of the embodiments described herein.

According to some embodiments, the method 400 may comprise determining (e.g., by a processing device) an image of an object, at 402. In the case that the processing device comprises a processing unit of a mobile computing device (tablet, smart phone, portable gaming device, etc.), for example, a camera (still and/or video) of the mobile computing device may transmit and/or the processing device may receive data descriptive of an object in proximity to the mobile computing device—e.g., a location image, an image of an individual, retail product, street sign, retail signage, and/or other object. In the case that the processing device comprises a central server and/or controller device, the controller device may receive the image data from the mobile (and/or remote computing device). According to some embodiments, the image data may define a still image (e.g., digital photo and/or image file), video image data, and/or real-time image transfer (e.g., video imagery captured by the camera and relayed to an output device for display, but not necessarily recorded for playback—e.g., a “viewfinder” mode of a digital camera).

In some embodiments, the method 400 may comprise identifying (e.g., by the processing device) a promotional target in the image, at 404. Portions of the image may be compared to stored image data, for example, to determine a match between a stored image pattern and a portion of the image data received at 402. The stored and/or matched image data may comprise, in some embodiments, information descriptive of pixel patterns, colors, and/or configurations that defined one or more image artifacts such as symbols, shapes, letters, words, facial features, clothing types, etc. In some embodiments, the stored image patterns may define and/or represent various retail and/or commercial features such as trade dress features (e.g., architectural features such as signage shapes, colors, patterns, and/or product shapes, sizes, feature, and/or configurations), trademarks, logos, etc. In such a manner, for example, the appearance of certain types of products, certain units of product (e.g., based on serial numbers, barcode data, etc.), certain stores, and/or other commercial features may be identified in received image data. As the image data, in some embodiments, is received in real-time from a mobile electronic device, it may be presumed that an object identified in the image data is in proximity to (if not in a field-of-view of) the mobile electronic device. In some embodiments, image data pattern matching may be utilized to establish, estimate, verify, and/or otherwise determine information descriptive of a location of the mobile device. Landmarks, street signs, license plate data, etc. may be utilized, for example, to determine device location. In some embodiments, image artifact data may be utilized in conjunction with GPS and/or sensor data to determine user device location (e.g., street address, outside location, and/or inside location—e.g., which aisle in a particular store) and/or orientation (e.g., field-of-view orientation).

According to some embodiments, the method 400 may comprise enhancing (e.g., by the processing device) the image with an indication of a promotion, at 406. Information (e.g., supplemental content such as promotional offer data) stored in association with the object identified at 404, for example, may be transmitted to the remote and/or mobile electronic device (e.g., user device). In some embodiments, the information may comprise instructions, commands, and/or code that causes the user device to perform certain functions. The information may, for example, cause an output device of the user device to display an interface that provides ARR functionality. The interface may, in some embodiments for example, cause portions of the image data captured by the user device to be altered, highlighted, and/or enhanced or modified. In the case that a promotional offer is determined to be related to a particular product in the field-of-view of the user device, for example, the interface may highlight the product and/or superimpose promotional offer data on or adjacent to portions of the image where the identified product appears. According to some embodiments, the ARR features provided to and/or effectuated by the user device may comprise Input/Output (I/O) features such as touch screen elements that enable a user to select and/or interact with the image enhancements (highlighting, etc.) implemented by the interface. In such a manner, for example, a user may utilize a smart phone or other mobile device to capture an image of a location (and/or product and/or object), view an overlay of promotional offers and/or other information superimposed on the image of the location (and/or product and/or object), and view, accept, commit to, sign-up for, and/or conduct a transaction in accordance with the indicated promotional offer.

Turning now to FIG. 5, a block diagram of a system 500 according to some embodiments is shown. The system 500 may, according to some embodiments, comprise a user device 502, a network 504, one or more third-party devices 506a-b (e.g., a merchant device 506a and/or a manufacturer device 506b), one or more sensor devices 508a-b, a controller device 510, a database device 540, and/or one or more units of product 560a-c (e.g., stored on and/or otherwise associated with a shelf 570). The system 500 may depict, for example, usage of an ARR application on the user device 502 in a retail environment such as a grocery store.

Fewer or more components 502, 504, 506a-b, 508a-b, 510, 540, 560a-c, 570 and/or various configurations of the depicted components 502, 504, 506a-b, 508a-b, 510, 540, 560a-c, 570 may be included in the system 500 without deviating from the scope of embodiments described herein. In some embodiments, the components 502, 504, 506a-b, 508a-b, 510, 540, 560a-c, 570 may be similar in configuration and/or functionality to similarly named and/or numbered components as described herein. In some embodiments, the system 500 (and/or portion thereof) may be utilized by and/or in conjunction with an ARR application program and/or platform programmed and/or otherwise configured to execute, conduct, and/or facilitate the methods 400, 900, 1500 of FIG. 4, FIG. 9, and/or FIG. 15, and/or portions or combinations thereof, described herein.

In some embodiments, the user device 502 may comprise a camera and/or other image input device (not explicitly shown in FIG. 5) having a field-of-view represented by the dotted lines in FIG. 5. As depicted, the user device 502 may be utilized to capture an image of the shelf 570 and/or the units or product 560a-c thereon. According to some embodiments, image data from the user device 502 may be transmitted, e.g., via the network 504, to one or more of the controller device 510 and the merchant device 506a and/or the manufacturer device 506b. In some embodiments, the controller device 510 may analyze the image data from the user device 502 and identify specific image artifacts and/or features within the image data. The controller device 510 may, for example, compare image patterns in the received image data to image patterns and/or data stored in the database 540 (e.g., image “targets”). Upon identification of an image target in the image data, the controller 510 may send data and/or instructions to the user device 502 defining an ARR application and/or functionality thereof.

In the case that an ARR image target comprising a brand logo is stored in the database 540, for example, the controller 510 may analyze image data received from the user device 502 to determine if the brand logo is present in the image. In such a manner, for example, the controller device 510 may determine an identity of one or more of the units of product 560a-c on the shelf 570 (e.g., of which the image data is descriptive). The identity of the unit of product 560a-c may be utilized (e.g., by the controller device 510) to identify supplemental content appropriate for ARR enhancement to an image of the unit of product 560a-c. In the case the a second unit of product 560b is determined to exist on the shelf 570 via image analysis, for example, the controller device 510 may query the database 540 and/or communicate with either or both of the merchant device 506a and the manufacturer device 506b to determine what supplemental content (if any) should be utilized for an ARR application involving the second unit of product. In some embodiments, as described herein, the supplemental content may be associated with and/or descriptive of one or more promotions involving the second unit of the product 560b (and/or any unit of such a brand of product or even any unit of product 560a-c associated with the user of the user device 502). According to some embodiments, the decision of whether to provide supplemental content and/or which supplemental content to provide may be at least partially governed by data received from one or more of the sensor devices 508a-b and/or from the user device 502. The sensor devices 508a-b and/or the user device 502 may provide locational context to the image data, for example, and may accordingly allow certain supplemental content (e.g., first supplemental content) to be selected and provided in certain locations (e.g., certain stores and/or certain geographic areas) while other supplemental content (e.g., second supplemental content) may be associated with and accordingly provided to users in other locations, despite being triggered by and/or based on the same image data and/or same ARR image target.

According to some embodiments, the supplemental data based on the image data and/or location data associated with the second unit of product 560b may be transmitted to the user device 502. The supplemental data may include and/or trigger instructions that when executed by the user device 502 (e.g., by an ARR software application thereof) cause an image of the second unit of product 560b to be enhanced—e.g., providing a virtual modification of the second unit of product 560b that, among other things, may allow the user to interact (virtually) with the second unit of product 560b. In some embodiments, such enhancements may be provided via an interface output via the user device 502.

Turning now to FIG. 6, for example, a perspective diagram of an example system 600 according to some embodiments is shown. In some embodiments, the system 600 may comprise user device 602 having a display device 616 that outputs an interface 620. The interface 620 may, for example, comprise output from an ARR application that is programmed to enhance real-world images with augmented and/or supplemental content. As depicted, for example, the interface 620 (via the display device 616) displays an image of a plurality of units of product 660a-c situated on a shelf 670. The user device 602 may, in some embodiments, comprise a camera (not shown in FIG. 6) that captures an image in the direction opposite of the output of the interface 620 (e.g., oriented opposite to the display device 616 that outputs the interface 620), allowing a user (not fully and/or explicitly shown in FIG. 6) to utilize the user device 602 as a virtual reality ‘frame’ or lens through which the shelf 670 (or other real-world location) may be viewed. The interface 620 may comprise, as depicted for example, a real-time image of the shelf 670 behind the user device 602 being held up by the user.

In some embodiments, the interface 620 may be augmented with data supplemental to the real-time, real-world image data received by the camera and output via the display device 616. The interface 620 may comprise, for example, a highlighting 622 of one or more objects or features in the real-time image. As depicted, for example, the highlighting 622 alters the portion of the real-time image corresponding to a first unit of product 660a. In such a manner, for example, the user's attention may be drawn to the first unit of product 660a and/or the highlighting 622 may comprise an indication that the first unit of product 660a has been locked-onto as an ARR target. In some embodiments, the highlighting 622 may change color, appearance, and/or animation based on whether the first unit of product 660a has been identified as an ARR target (e.g., an image for which a stored representation in a database and associated supplemental content corresponds).

According to some embodiments, the interface 620 may comprise other and/or additional enhancements to the real-time and/or real-world image output by the display device 616. The interface 620 may comprise, for example, one or more image enhancements 626a-c. A first image enhancement 626a may, for example, comprise an addition of features resulting in a virtual personification of the first unit of product 660a. The first image enhancement 626a may comprise, in some embodiments, animated legs, eyes, arms, a mouth, and/or other features added to the virtual representation of the first unit of product 660a. In some embodiments, the first image enhancement 626a and/or components thereof may comprise interactive features. The display device 616 may comprise a touch screen device, for example, and may accept input corresponding to the displayed representations of the first image enhancement 626a features. In such a manner, for example, the user may tickle, pet, and/or otherwise interact with and/or animate the virtual representation of the first unit of product 660a.

In some embodiments, a second image enhancement 626b may comprise a product rating menu. The second image enhancement 626b may, as depicted for example, comprise one or more graphical elements such as rating stars via which the user may view, edit, and/or modify or otherwise interact with a rating for the first unit of product 660a. In such a manner, for example, the user may utilize the interface 620 to rate a product based on an image of the product captured by the user device 602. While the example first unit of product 660a comprises a can of soup, it should be understood that many other types of products and even services (or results thereof) may also or alternatively be enhanced in such a manner. The user may take a picture of a meal and utilize the ARR interface 620, for example, to rate the chef and/or restaurant that prepared the meal or rate the recipe via which the meal was prepared.

According to some embodiments, a third image enhancement 626c may comprise a virtual button, drop-down menu, and/or expandable virtual feature such as the depicted nutritional information button. In such a manner, for example, nutritional information for the first unit of product 660a may readily be accessed by simply utilizing the ARR interface 620 while standing in front of the first unit of product 660a. Such functionality may save time by not requiring the user to physically interact with the first unit of product 660a to acquire the nutritional information, may provide more nutritional and/or other information than can be (or is) printed on a label of the first unit of product 660a (e.g., that would not be readily accessible via the physical first unit of product 660a itself), and/or may be particularly advantageous for units of product 660a-c stored behind glass doors and/or that are otherwise not readily accessible to the user (e.g., below or on top of other units of product not explicitly shown and/or otherwise out of reach).

In some embodiments, any or all of the highlighting 622 and image enhancements 626a-c may be updated and/or modified (i) as the user and/or user device 602 move, (ii) as time passes (e.g., the interface 620 may change based on time windows and/or triggers), and/or (iii) based on information received from other devices (such as the merchant device 106, sensor devices 108a-c, and/or controller device 110 of FIG. 1). In some embodiments, any or all of the highlighting 622 and the image enhancements 626a-c may be defined and/or implemented based on (i) the location of the user and/or user device 602, (ii) characteristics of the user and/or user device 602 (e.g., user preferences, demographics, etc.), and/or (iii) image artifacts identified in the image (e.g., brand logos, store names, etc. —as described herein).

Fewer or more components 602, 616, 620, 622, 626a-c and/or various configurations of the depicted components 602, 616, 620, 622, 626a-c may be included in the system 600 without deviating from the scope of embodiments described herein. In some embodiments, the components 602, 616, 620, 622, 626a-c may be similar in configuration and/or functionality to similarly named and/or numbered components as described herein. In some embodiments, the user device 602 (and/or portion thereof) may comprise an ARR program and/or platform programmed and/or otherwise configured to execute, conduct, and/or facilitate the methods 400, 900, 1500 of FIG. 4, FIG. 9, and/or FIG. 15, and/or portions or combinations thereof, described herein.

Referring now to FIG. 7, a block diagram of a system 700 according to some embodiments is shown. The system 700 may, according to some embodiments, comprise a plurality of user devices 702a-d, a network 704, a third-party device 706, a controller device 710, a database device 740, a unit of product 760, and/or a particular location 770. The system 700 may depict, for example, usage of an ARR application on a first user device 702a in a retail environment such as to receive, provide, define, and/or disseminate product recommendations, ratings, and/or other supplemental data.

In some embodiments, the first user device 702a may capture data descriptive of the unit of product 760 at the location 770 (depicted by the dashed lines in FIG. 7). The information may be captured, for example, by a camera device, barcode scanner, and/or other optical, imaging, and/or electronic signal interrogation device (none of which are explicitly shown in FIG. 7). In some embodiments, the captured information may be utilized (e.g., by the first user device 702a and/or the controller device 710) to identify the product 760. The first user device 702a may be utilized to provide a rating and/or recommendation (or other supplemental content) for the identified product. In some embodiments, the rating and/or recommendation (and/or other user-selected and/or user-defined data) may be provided by the first user device 702a to the controller device 710.

According to some embodiments, the controller device 710 may store user-defined and/or user-selected data received from the first user device 702a. The controller device 710 may, for example, store (e.g., in the database 740) a rating and/or recommendation for the product defined and/or chosen by the user for the unit of product 760. In some embodiments, the controller device 710 may identify and/or select other users and/or devices to which indications of the user-defined/selected rating/recommendation should be provided. The controller device 710 may, for example, query the database 740 and/or the third-party device 706 to determine one or more other devices and/or users associated with the first user device 702a (and/or the user thereof).

In some embodiments, the controller device 710 may propagate and/or transmit or otherwise provide the user-defined and/or user selected information (e.g., from the first user device 702a) to one or more other user devices 702b-d. The controller device 710 may, for example, determine and/or identify a second user device 702b and/or a third user device 702c that are present at (and/or otherwise associated with) the particular location 770 (e.g., the same location at which the first user device 702a has been utilized to identify and/or provide rating or other information descriptive of the unit of product 760). According to some embodiments, the controller device 710 may interface with the third-party device 706 to communicate with and/or provide the user-defined and/or user-selected information to the third user device 702c. The third-party device 706 may comprise, for example, a communication provider device such as a device of a telecommunications carrier or an Internet Service Provider (ISP), or may comprise a social network server and/or device. The third user device 702c may, for example, comprise a device owned and/or operated by a social network ‘friend’ and/or other predefined contact of the user of the first user device 702a. In some embodiments, a fourth user device 702d may also or alternatively be provided with the user-defined and/or user-selected information descriptive of and/or relating to the unit of product 760. The fourth user device 702d may comprise a device operated by a ‘friend’ of the user of the first user device 702a, for example, and/or may comprises a device associated with a demographic and/or other category for which information relating to the unit of product 760 is determined to be relevant (e.g., based on stored rules and/or logic implemented by the controller device 710). As depicted, the fourth user device 702d may not necessarily be located at the particular location 770.

According to some embodiments, the user-defined and/or selected data provided by the first user device 702a may comprise a recommended product price, discount, and/or other product-related parameter for the unit of product 760 (and/or for any unit of the same type of product). The first user device 702a may be utilized, for example, to identify the unit of product 760 and define or select a discount or other promotion desired by a user of the first user device 702a. The first user device 702a may, in other words, be utilized to initiate a user-driven discount and/or promotional campaign. In some embodiments, the user-initiated discount and/or promotion may be propagated to the other user devices 702b-d (and/or a selected subset thereof) for voting and/or input. The other user devices 702b-d may, for example, provide indications of votes and/or commitments to purchase or participate in the user-initiated promotion to the controller device 710 (and/or to the first user device 702a, such as in the case that the first user device 702a facilitates and/or manages user-initiated promotion communications). According to some embodiments, if the user-initiated promotion receives enough votes and/or commitments to participation, the user-initiated promotion may be activated with respect to the unit of product 760 (and/or other units of the same product type, not shown). In such a manner, for example, a customer in a store (e.g., the particular location 770) may scan or take a picture of a product (e.g., the unit of product 760), suggest a price, discount, and/or other promotion, and send or broadcast the promotion to a user group (e.g., users in the same store, in the same town, having an interest and/or characteristic in common). Responses and/or participation of the user community may cause the promotion to become active, e.g., possibly even before the user of the first user device 702a reaches a checkout counter with the unit of product 760. In such embodiments, the user-initiated promotion may be utilized to increase sales of plentiful and/or desirable inventory based on real-time demand. In some embodiments, the user-initiated promotion may instead function for products with low inventory. In the case that the unit of product 760 is the last unit available at the particular location 770, for example, the user-initiated promotion may comprise an auction where either the store or the user of the first user device 702a have possession of the last available unit of product 760 and are willing to sell it to a high bidder. Such a low-inventory auction embodiment may be particularly advantageous in the case that the other user devices 702b-c at the particular location 770 are identified (e.g., utilizing image recognition and/or various wireless location techniques as described herein), allowing the unit of the product 760 to be readily transferred to the highest bidder at the particular location 770.

Fewer or more components 702a-d, 704, 706, 710, 740, 760, 770 and/or various configurations of the depicted components 702a-d, 704, 706, 710, 740, 760, 770 may be included in the system 700 without deviating from the scope of embodiments described herein. In some embodiments, the components 702a-d, 704, 706, 710, 740, 760, 770 may be similar in configuration and/or functionality to similarly named and/or numbered components as described herein. In some embodiments, the system 700 (and/or portion thereof) may be utilized by and/or in conjunction with an ARR application program and/or platform programmed and/or otherwise configured to execute, conduct, and/or facilitate the methods 400, 900, 1500 of FIG. 4, FIG. 9, and/or FIG. 15, and/or portions or combinations thereof, described herein.

Turning now to FIG. 8, an example interface 820 according to some embodiments is shown. In some embodiments, the interface 820 may comprise a web page, web form, database entry form, Application Programming Interface (API), spreadsheet, table, and/or application or other GUI via which a consumer, customer, patron and/or other user or entity may capture information descriptive of a location, product, item, and/or other object and review, retrieve, define, select, and/or otherwise interface with information supplemental thereto, such as via an ARR application. The interface 820 may, for example, comprise and/or be generated by an ARR application and/or platform programmed and/or otherwise configured to execute, conduct, and/or facilitate any of the methods 400, 900, 1500 of FIG. 4, FIG. 9, and/or FIG. 15 and/or portions and/or combinations thereof described herein. In some embodiments, the interface 820 may be output via a computerized device (e.g., a processor or processing device) such as one or more of the user devices 102, 202, 502, 702a-d and/or the controller devices 110, 510, 710 of FIG. 1, FIG. 5, and/or FIG. 7 herein. In some embodiments, the example interface 820 may comprise interface outputs of (and/or otherwise associated with) a GUI utilized to interact virtually with real-world locations and/or objects (such as retail products), such as may be implemented and/or provided as described herein. According to some embodiments, the interface 820 may comprise an ARR interface configured to allow a user to interact virtually with a unit of a product in a store (e.g. a unit of product that the user does not yet own).

In some embodiments, the interface 820 may comprise various highlighting 822, image modification 824, and/or image enhancements 826a-i. As depicted for non-limiting exemplary purposes in FIG. 8, an image of a unit of product 860 such as a can of soup may be enhanced, such as via ARR application functionality by overlaying and/or superimposing any or all of the highlighting 822, image modifications 824, and/or image enhancements 826a-i thereupon. The highlighting 822 may, for example, modify the appearance of the product to draw a user's attention to various attributes of the product or to various ARR modifications thereof. As depicted, for example, the highlighting 822 may be configured (e.g., placed and/or defined with various visual attributes such as colors and/or animations) to attract the user's attention to the label of the can. In some embodiments, the highlighting 822 may be configured to function with and/or complement other ARR features such as the image modification 824. The image modification 824 may, for example, comprise a lottery and/or “INSTANT WIN” notification and/or feature that replaces the logo or another portion of the label on the product in the image. In some embodiments, the image modification 824 may inform a user of an award or other benefit (e.g., an ‘instant win’) that the user has achieved. In such a manner, for example, a user may approach a product on a shelf in a store and view the product through the interface 820 (and/or utilizing the interface 820) to see if the user has won a prize (e.g., associated with the product). In some embodiments, the prize may be associated with a particular product. The image modification 824 may only appear on the interface 820, for example, in the case that the product in the image is determined to be a product for which an instant win, lottery, and/or other prize option is available. In some embodiments, the highlighting 822 and/or the image modification 824 may comprise interactive features. The user may select (e.g., via touch and/or other electronic selection methodologies) the highlighting 822 and/or the image modification 824, for example, to activate stored rules and/or logic associated therewith. In some embodiments, activation of the highlighting 822 and/or the image modification 824 may cause a result of an “INSTANT WIN” game and/or prize to be revealed.

According to some embodiments, a first image enhancement 826a may comprise an indication of a sweepstakes associated with the product, user, and/or a location of the product and/or user. The first image enhancement 826a may, for example, display a number of sweepstakes points or entries associated with the user and/or user device (not shown in FIG. 8) outputting the interface 820. In some embodiments, the user may accumulate sweepstakes entries by utilizing the interface 820 to interact with products, locations, and/or other objects.

In some embodiments, the interface 820 may comprise a second image enhancement 826b such as an indicator of a price of the product and/or a third image enhancement 826c such as an indicator of a discount and/or other special pricing feature associated with the product, user, and/or location. In some embodiments, the user may select and/or interact with the second image enhancement 826b and/or the third image enhancement 826c to adjust the price and/or discount of the product. The user may, for example, recommend a discount and/or recommend a price for the product. Such user-defined (and/or selected) pricing data may, in some embodiments, be transmitted to other users, merchants, manufacturers, and/or third-parties for voting, participation, and/or approval.

According to some embodiments, the interface 820 may comprise a fourth image enhancement 826d that comprises a product (and/or location—such as a particular store) rating and/or recommendation feature. In some embodiments, the fourth image enhancement 826d may provide rating information for the product based on recommendations from all participating users, recommendations from users that are friends of the user of the interface 820, and/or users that are in the same geographic area as the user (e.g., currently in the same store, mall, and/or other defined geo-locational area). The fourth image enhancement 826d may be utilized, for example, to accept rating and/or recommendation input from the user.

In some embodiments, the interface 820 may comprise a fifth image enhancement 826e that comprises a “Shopping Buddies” feature. The fifth image enhancement 826e may, for example, display images (e.g., thumbnail images, profile images, etc.) of other users having a relationship with the present user such as Facebook® and/or other social network ‘friends’, contacts, colleagues, etc. the fifth image enhancement 826e may also or alternatively provide data related to such “buddies” such as ratings, recommendations, communications (e.g., text and/or instant messages), suggestions, etc. According to some embodiments, the fifth image enhancement 826e may enable the user to initiate voice and/or video communications with one or more selected “buddy”. In some embodiments, the “shopping buddies” may be associated with one or more promotions and/or rewards such as the “INSTANT WIN” functionality of the image modification 824 and/or the sweepstakes functionality of the first image enhancement 826a. The user and one or more of the “shopping buddies” may act as a team, for example, earning sweepstakes entries, instant win chances, and/or other rewards and/or chances for rewards.

According to some embodiments, the interface 820 may comprise a sixth image enhancement 826f such as a “cooking” feature. The sixth image enhancement 826f may, for example, be configured to allow the user to view and/or access recipes related to the product in the image, to assist (e.g., via ARR applications) with recipe preparations, and/or identify and/or locate related products (e.g., other products utilized in the same selected recipe).

In some embodiments, the interface 820 may comprise a seventh image enhancement 826g such as a “trivia” feature. The seventh image enhancement 826g may, for example, be configured to allow the user to access and/or view trivia questions relating to the product in the image (or the location in the image) and/or to play one or more games related to the product such as trivia games (e.g., single-player or with one or more other users such as one or more of the “shopping buddies”). In some embodiments, the seventh image enhancement 826g may also or alternatively comprise information descriptive of other uses for the product. While the user may initially be interested in the product for inclusion in a food recipe, for example, the seventh image enhancement 826g may inform the user that the product is also useful for some other purposes such as keeping away mosquitoes, helping geraniums grow, etc. In some embodiments, the provided trivia questions and/or other use information may be selected based on not only the product and/or location, but based on characteristics of the user as well. In the case that it is known that the user likes skiing, for example, uses of the product relating to skiing may be provided.

According to some embodiments, the interface 820 may comprise an eighth image enhancement 826h such as a “related products” feature. The eighth image enhancement 826h may, for example, provide information descriptive of products related (in a variety of ways) to the product in the image. Similar to the sixth image enhancement 826f, for example, the eighth image enhancement 826h may inform the user of products related to the current product by virtue of being included in the same recipe. Other types of related products may comprise products having package pricing and/or discount deals when purchased with the current product, products that complement the current product nutritionally, and/or products that are on the same list as the current product (e.g., grocery list, food pantry list, from the same manufacturer, from the same region, etc.).

In some embodiments, the interface 820 may comprise a ninth image enhancement 826i such as a “news” feature. The ninth image enhancement 826i may, for example, provide data descriptive of recent news, events, recalls, sell-by and/or good-by dates, and/or other informational items relating to the product (and/or location).

Any or all of the highlighting 822, the image modification 824, and/or the image enhancements 826a-i may be updated and/or modified (i) as the user and/or user device move, (ii) as time passes (e.g., the interface 820 may change based on time windows and/or triggers), and/or (iii) based on information received from other devices (such as the merchant device 106, sensor devices 108a-c, and/or controller device 110 of FIG. 1). In some embodiments, any or all of the highlighting 822, the image modification 824, and/or the image enhancements 826a-i may be defined and/or implemented based on (i) the location of the user and/or user device, (ii) characteristics of the user and/or user device (e.g., user preferences, demographics, etc.), and/or (iii) image artifacts identified in the image (e.g., brand logos, store names, etc. —as described herein).

While various components of the interface 820 have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Turning now to FIG. 9, a flow diagram of a method 900 according to some embodiments is shown. In some embodiments, the method 900 may be implemented, facilitated, and/or performed by or otherwise associated with the system 700 of FIG. 7 herein (and/or portions thereof, such as the user devices 702a-d and/or the controller device 710). In some embodiments, the method 900 may be implemented via a Graphical User Interface (GUI) such as one or more of the interfaces 220, 620, 820, 1020, 1320, 1420 of FIG. 2, FIG. 6, FIG. 8, FIG. 10, FIG. 13, and/or FIG. 14 herein.

According to some embodiments, the method 900 may comprise receiving (e.g., by a processing device) image data from user device, at 902. The image data may, for example, be descriptive of a location, product, and/or other object in proximity to the user device.

In some embodiments, the method 900 may comprise identifying (e.g., by the processing device) an object in the image, at 904. Stored image data may be queried, for example, to determine whether any pixel and/or other image patterns or characteristics of the image match stored patterns and/or characteristics. The stored data may, in some embodiments, be associated with an identifier and/or other information descriptive of an identity of the matched pattern. In some embodiments, such as in the case that multiple patterns are matched, location and/or orientation information may be derived from the matching process. It may be known, for example, that there are only two (2) locations where a certain store using a particular logo is situated across the street from a particular type of church or other distinguishable building or feature. In the case that both the store and the church are identified in the received image data, it may be determined and/or assumed that the user device is located at one of the two (2) known locations. Locational data from the user device and/or from sensors proximate to the user device may be utilized, in some embodiments, to determine which of the two (2) locations the user device is in.

According to some embodiments, the method 900 may comprise determining (e.g., by the processing device) supplemental data stored in association with the object, at 906. Once an object is identified as being in proximity to the user device, information stored in associated with the object may be retrieved and/or provided to the user device. The supplemental information may comprise, for example, promotional offers, rating and/or recommendation information, trivia questions and/or answers, pricing information, purchase information, handling and/or usage instructions, nutritional information, etc.

In some embodiments, the method 900 may comprise receiving (e.g., by the processing device) an update to the supplemental data, at 908. The user device may be utilized, for example, to modify and/or add to the supplemental information. According to some embodiments, for example, the user of the user device may select the identified object (e.g., a unit of a particular brand of product, for exemplary purposes) and select, enter, and/or define rating and/or recommendation information. The user may rate the identified product, for example, and/or may suggest or recommend the product. In some embodiments, the user may select and/or define a recommended promotion relating to the product such as a suggestion that the product be offered for a discount (e.g., percentage off, amount off, or a particular sale price).

According to some embodiments, the method 900 may comprise selecting (e.g., by the processing device) a set of user devices, at 910. One or more other user devices (e.g., other than the device that provided the image data and/or the user-defined and/or user-selected supplemental data) may, for example, be selected from a plurality of available and/or known user devices. In some embodiments, user devices associated with users (e.g., second users) that have social networking relationships with (e.g., are ‘friends’ of) the user of the image-capturing user device (e.g., a first user) may be selected, identified, and/or located. According to some embodiments, user devices in proximity to the identified unit of product, in proximity to a different unit of the identified product (e.g., in a different store), and/or in proximity to the first user and/or user device, may be selected, identified, and/or located. In some embodiments, the selecting may be performed in real-time—e.g., upon receiving the user-defined/user-selected supplemental information from the first user. According to some embodiments, previous purchases and/or preferences (e.g., relating to the identified product) of other users may be utilized to select the desired set and/or subset of other user devices.

In some embodiments, the method 900 may comprise providing (e.g., by the processing device) updated supplemental data to selected set of user devices, at 912. Updated rating, recommendation, and/or recommended discount or promotional information may be provided, for example, to the set and/or subset of user devices selected at 910. In some embodiments, the information may be made available to (e.g., access may be provided) the updated supplemental information. In some embodiments, the updated supplemental information and/or an indication of the update itself may be pushed (e.g., transmitted) to the selected user devices. The transmitting may occur real-time (i.e., as or immediately after the information is updated by the first) user or may occur at triggered times after the updating. The transmitting may occur, for example, when a user operating one of the selected user devices walks within a predetermined distance of the identified unit of product, another unit of the identified product, a location where the first user updated the information, and/or a current location of the first user.

According to some embodiments, the method 900 may comprise receiving (e.g., by the processing device) votes, at 914. Users of the selected user devices may, for example, transmit indications of whether or not they agree with the update provided by the first user. In some embodiments, such as in the case that the first user's rating, recommendation, or other supplemental data receives more than a threshold number of votes, approvals, and/or exceeds a particular user rating, the first user may be awarded a benefit such as a discount on a purchase of the identified unit of product, a different unit of the product, or a different product (e.g., subsidized by a competing manufacturer or brand). In such a manner, for example, the first user may capture an image of a product as they are walking through a store, provide information relating to the product (e.g., a rating, a recommendation for others to buy, and/or a “wish list” request—e.g., “help me buy”), the information may be transmitted to other users (e.g., users having a relation to the first user), the other users may vote and/or participate based on the first user's provided information relating to the product, and the first user may receive a discount or other benefit, all possibly occurring before the first user reaches the checkout. Indeed, in some embodiments, the award provided to the first user may be provided as part of a transaction for the purchase of the identified unit of product before the first user leaves the store in which the image was originally captured.

In some embodiments, such as in the case that the user-defined and/or user-selected supplemental data comprises a recommended discount and/or promotion for a product, votes and/or offers or commitments of participation from other users may cause the suggested promotion to be implemented. A certain number of votes and/or commitments of participation (e.g., commitments to purchase a product at a particular price) may, for example, trigger implementation of the user-initiated promotional pricing for a product.

Referring now to FIG. 10, an example interface 1020 according to some embodiments is shown. In some embodiments, the interface 1020 may comprise a web page, web form, database entry form, API, spreadsheet, table, and/or application or other GUI via which a consumer, customer, patron and/or other user or entity may capture information descriptive of a location, product, item, and/or other object and review, retrieve, define, select, and/or otherwise interface with information supplemental thereto, such as via an ARR application. The interface 1020 may, for example, comprise and/or be generated by an ARR application and/or platform programmed and/or otherwise configured to execute, conduct, and/or facilitate any of the methods 400, 900, 1500 of FIG. 4, FIG. 9, and/or FIG. 15 and/or portions and/or combinations thereof described herein. In some embodiments, the interface 1020 may be output via a computerized device (e.g., a processor or processing device) such as one or more of the user devices 102, 202, 502, 702a-d and/or the controller devices 110, 510, 710 of FIG. 1, FIG. 5, and/or FIG. 7 herein. In some embodiments, the example interface 820 may comprise interface outputs of (and/or otherwise associated with) a GUI utilized to interact virtually with real-world locations and/or objects (such as retail products), such as may be implemented and/or provided as described herein. According to some embodiments, the interface 1020 may comprise an ARR interface configured to allow a user to interact virtually with a unit of a product at the use's home (e.g. a unit of product that the user already owns).

In some embodiments, the interface 1020 may comprise various highlighting 1022a-b, image modification 1024, and/or image enhancements 1026a-f. As depicted for non-limiting exemplary purposes in FIG. 10, an image of one or more units of product 1060a-b such as a box of salt 1060a (e.g., a first unit of product 1060a) and/or a can of tomato paste 1060b (e.g., a second unit of product 1060b) can may be enhanced, such as via ARR application functionality by overlaying and/or superimposing any or all of the highlighting 1022a-b, image modification 1024, and/or image enhancements 1026a-f thereupon. The highlighting 1022a-b may, for example, modify the appearance of the units of product 1060a-b to convey information to the user. As depicted, for example, a first highlighting 1022a of the first unit of product 1060a may be configured (e.g., placed and/or defined with various visual attributes such as colors and/or animations) to indicate to the user that the first unit of product 1060a is not currently on a grocery list of the user's but that the first unit of product 1060a is not determined to be in need of imminent replacement (e.g., is not necessary to add to the grocery list at the current time). The first highlighting 1022a may, for example, illuminate and/or outline the first unit of product 1060a in a neutral color such as white or blue.

According to some embodiments, a second highlighting 1022b of the second unit of product 1060b may be configured (e.g., placed and/or defined with various visual attributes such as colors and/or animations) to indicate to the user that the second unit of product 1060b is not currently on the grocery list of the user's but that the second unit of product 1060b is determined to be in need of imminent replacement. It may be determined, for example, that too few inventory of the same type of product as the second unit of product 1060b (e.g., tomato paste) are currently possessed by the user and/or that a calculated rate of consumption (historic or predicted) of the type of product by the user (e.g., the user's family) will consume the current inventory of the product within a predetermined threshold amount of time such as a few days, a week, etc. (e.g., depending on how frequently the user desires to visit the grocery store and/or how much warning the user desires for impending out-of-stock situations). The second highlighting 1022b may, for example, illuminate and/or outline the second unit of product 1060b in a warning or action color such as red—denoting that it is suggested that the type of product be added to the grocery list.

In some embodiments, the interface 1020 may comprise the image modification 1024. While the actual brand of tomato paste of the second unit of product 1060b may comprise “BRAND A”, for example, the interface 1020 may replace the actual real-world brand, logo, trademark, etc. with the image modification 1024. In some embodiments, the replacement utilizing the image modification 1024 may comprise an updated and/or different version of image and/or logo from “BRAND A”, thereby allowing static labels on real-world products to be updated and/or enhanced via an ARR virtual interaction and/or modification. According to some embodiments, the image modification 1024 replace the “BRAND A” image portion with a “BRAND B” logo, image, trademark, and/or other supplemental virtual information. In the case that the second unit of product 1060b is determined to be in need of replacement (e.g., as indicated by the second highlighting 1022b), for example, a discount, offer, and/or product-placement and/or marketing arrangement with “BRAND B” may cause the image modification 1024 to replace the indication of “BRAND A” with one of “BRAND B”—e.g., suggesting to the user that upon replacement of the second unit of product 1060b, that a “BRAND B” version of the product be purchased instead of a “BRAND A” version.

According to some embodiments, a first image enhancement 1026a may comprise a virtual product fill line or “X-ray” view of the first unit of product 1060a. Based on purchase date and product consumption information (e.g., consumption rate, upcoming expected usage in recipes), for example, an amount of the first unit of product 1060a remaining may be calculated and projected in a virtual manner on the real-world container via the interface 1020 and the first image enhancement 1026a. In such a manner, for example, the user may scan a pantry and/or refrigerator shelf to quickly determine how much product remains in various containers without the need of picking up the containers, much less opening them.

In some embodiments, the interface 820 may comprise a second image enhancement 1026b such as a virtual grocery list. The second image enhancement 1026b may provide a listing of all current products and/or quantities on the user's grocery list, for example, and may provide an indication of an excepted shopping cart price total based on prices at one or more stores (such as a user's preferred store(s), stores within a certain geographic proximity such as within ten (10) miles, and/or stores offering discounts or other benefits to the user). In some embodiments, a third image enhancement 1026c may be provided to allow the user to quickly and easily add products to the grocery list and/or a fourth image enhancement 1026d may be provided to allow the user to quickly and easily remove products from the grocery list. While the first unit of product 1060a may not be automatically placed on the grocery list because it is not predicted to be in short supply until a subsequent grocery trip and the first highlighting 1022a may accordingly be white or blue, for example, upon simple touch selection of the first highlighting 1022a (e.g., a portion of the interface 1020 corresponding to the first unit of product 1060a) and selection of the third image enhancement 1026c, the first highlighting 1022a may change to green to indicate that the first unit of product 1060a has been added to the grocery list. Similarly, the second highlighting 1022b of red indicating that the second unit of product 1060b should be added to the grocery list may be changed to green (indicating an addition to the grocery list) by selection of the second unit of product 1060b (e.g., by touch selection of an area of the interface 1020 corresponding to the second unit of product 1060b) and/or selection of the third image enhancement 1026c.

According to some embodiments, the interface 1020 may comprise a fifth image enhancement 1026e that comprises a recipe and/or cooking feature. The fifth image enhancement 1026e may, for example, provide access to recipes requiring one or more of the first unit of product 1060a and/or the second unit of product 1060b (both, in the case each is selected by the user, for example), cooking instructions, cooking assistance, etc. In some embodiments, the grocery list may be linked to recipes selected via the fifth image enhancement 1026e, causing missing products (e.g., products not currently in the user's possession—e.g., pantry, refrigerator, and/or freezer) to be automatically added to the list in appropriate quantities to allow the recipe to be completed.

In some embodiments, the interface 1020 may comprise a sixth image enhancement 1026f such as a “virtual measuring cup” feature. The sixth image enhancement 1026f may, for example, be configured to enhance an image of a pan, pot, dish, spoon, measuring cup, and/or other kitchen utensil to assist with cooking and/or baking (e.g., in accordance with a recipe provided via the fifth image enhancement 1026e). While not shown in FIG. 10, for example, an image of a measuring cup may be modified virtually with an imaginary line and/or fill level such as the virtual product fill line provided by the first image enhancement 1026a. In such a manner, for example, the user may utilize the interface 1020 to identify a product, identify a recipe that requires the product, automatically add other products required for the recipe to a shopping list, capture a real-time image of a measuring cup (pan, etc.), and view the required fill level for ingredients and/or recipe steps virtually superimposed on the actual cooking utensils utilized by the user. In some embodiments, the interface 1020 may virtually measure the user's cooking utensils utilizing image analysis to determine cooking (e.g., recipe) instruction based on actual pan sizes, etc., utilized in meal preparation.

Any or all of the highlighting 1022a-b, the image modification 1024, and/or the image enhancements 1026a-f may be updated and/or modified (i) as the user and/or user device move, (ii) as time passes (e.g., the interface 1020 may change based on time windows and/or triggers), and/or (iii) based on information received from other devices (such as the merchant device 106, sensor devices 108a-c, and/or controller device 110 of FIG. 1). In some embodiments, any or all of the highlighting 1022a-b, the image modification 1024, and/or the image enhancements 1026a-f may be defined and/or implemented based on (i) the location of the user and/or user device, (ii) characteristics of the user and/or user device (e.g., user preferences, demographics, etc.), and/or (iii) image artifacts identified in the image (e.g., brand logos, store names, etc. —as described herein).

While various components of the interface 1020 have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Referring now to FIG. 11, a block diagram of a system 1100 according to some embodiments is shown. The system 1100 may, according to some embodiments, comprise a user device 1102, a network 1104, a merchant device 1106, a plurality of smart appliance devices 1108a-d (e.g., a smart refrigerator 1108a, a smart shelf sensor 1108b, a smart toaster 1108c, and/or an other smart device 1108d), a controller device 1110, a database device 1140, a plurality of units of product 1160a-c, and/or a smart shelf 1170. The system 1100 may depict, for example, usage of an ARR application on the user device 1102 in a home environment such as to define, update, and/or manage one or more shopping lists, recipes, and/or cooking processes.

In some embodiments, the system 1100 may be utilized to take inventory and/or predict inventory and/or replenishment purchase dates for a user's home food stores and/or other consumable products possessed and/or desired by a user. The user device 1102 may interact with the smart refrigerator 1108a and/or the smart shelf 1170 (e.g., via the smart shelf sensor 1108b), for example, to determine inventory levels via image analysis techniques such as those described herein. According to some embodiments for example, the user device 1102, smart refrigerator 1108a, and/or the smart shelf 1170 (e.g., via the smart shelf sensor 1108b) may capture an image of the various units of product 1160a-b disposed within the smart refrigerator 1108a and/or upon the smart shelf 1170, respectively. Image data may be transmitted to the user device 1102 and/or the controller device 1110, either of which (or the combination of which) may process the image data to determine various characteristics of the units of product 1160a-b in inventory—e.g., brands, manufacturers, expiration and/or best-by dates, batch or lot numbers, flavors, styles, quantities, etc. Image data descriptive of one or more of the units of product 1160a-b may, for example, be compared to image data stored in the database 1140 to determine an identity and/or other information descriptive of the imaged one or more of the units of product 1160a-b. In some embodiments, image and/or product data may be sent (e.g., via the user device 1102 and/or the controller device 1110) to the merchant device 1106 to query information relating to an identified product (and/or to facilitate identification of a product based on image data).

According to some embodiments, the smart refrigerator 1108a and/or the smart shelf 1170 (and/or the smart shelf sensor 1108b thereof) may comprise and/or be utilized in place of the user device 1102. The smart refrigerator 1108a may comprise, for example, an image capture device such as a camera (not explicitly shown in FIG. 11) that captures image data of first units of product 1160a-1, 1160a-2 stored inside of the smart refrigerator 1108a. The camera of the smart refrigerator 1108a may be configured and/or coupled, for example, to capture image data every time a door of the smart refrigerator 1108a is closed, and/or at other predefined and/or random sampling intervals. Similarly, the smart shelf sensor 1108b may comprise a camera device coupled to capture images of second units of product 1160b-1, 1160b-2, 1160b-3 stored on the smart shelf 1170. According to some embodiments, the user device 1102 may be utilized to capture some or all of the desired image data and/or itself may be coupled to one or more of the smart refrigerator 1108a and/or the smart shelf 1170 (and/or the smart shelf sensor 1108b) thereof.

In some embodiments, the system 1100 may be utilized to facilitate cooking and/or baking of one or more of the units of product 1160a-b. The user device 1102 may be utilized, for example, to interface with the smart toaster 1108c to toast a third unit of product 1160c to desires specifications. The user device 1102 may, in some embodiments, transmit data identifying the third unit of product 1160c to the smart toaster 1108c. The smart toaster 1108c may then utilize stored toasting guidelines and/or access appropriate guidelines for the particular third unit of product 1160c from the user device 1102 and/or from the controller device 1110, database 1140, and/or merchant device 1106. The user device 1102 may be utilized, for example, to virtually load the third unit of product 1160c into the smart toaster 1108c and select a desired toast color, shade, and/or degree. The smart toaster 1108c may determine, based on the user input of desired outcome variables and the determined characteristics of the third unit of product 1160c, how long to toast and/or at what temperature or setting to toast. In some embodiments, such as in the case that the smart toaster 1108c is outfitted with an image capture device (not shown in FIG. 11) and/or with a transponder configured to communicate with a device attached to and/or integral to the third unit of product 1160c (e.g., RFID and/or NFC modules), the smart toaster 1108c may identify the third unit of product 1160c itself and/or determine and/or acquire the appropriate toasting setting thereof.

According to some embodiments, image and/or characteristic data of units of product 1160a-c may be utilized by the other device 1108d to facilitate other and/or additional cooking, baking, fabrication, and/or preparation instructions. The other device 1108d may comprise a smart measuring cup as described herein, for example, that is configured to alert the user when an appropriate amount of a selected unit of product 1160a-c has been placed in a real-world measuring device—e.g., utilizing image analysis to approximate a virtual determination that the amount placed equals a desired amount (e.g., an amount in accordance with a selected recipe and/or other set of instructions).

Fewer or more components 1102, 1104, 1106, 1108a-d, 1110, 1140, 1160a-c, 1170 and/or various configurations of the depicted components 1102, 1104, 1106, 1108a-d, 1110, 1140, 1160a-c, 1170 may be included in the system 1100 without deviating from the scope of embodiments described herein. In some embodiments, the components 1102, 1104, 1106, 1108a-d, 1110, 1140, 1160a-c, 1170 may be similar in configuration and/or functionality to similarly named and/or numbered components as described herein. In some embodiments, the system 1100 (and/or portion thereof) may be utilized by and/or in conjunction with an ARR application program and/or platform programmed and/or otherwise configured to execute, conduct, and/or facilitate the methods 400, 900, 1500 of FIG. 4, FIG. 9, and/or FIG. 15, and/or portions or combinations thereof, described herein.

Turning now to FIG. 12, a block diagram of a system 1200 according to some embodiments is shown. The system 1200 may, according to some embodiments, comprise a user device 1202, a network 1204, a manufacturer device 1206, a plurality of sensor devices 1208b, a controller device 1210, a database device 1240, a plurality of units of product 1260a-b, and/or a plurality of smart shelves 1270a-b. The system 1200 may depict, for example, usage of an ARR application on the user device 1202 in a retail environment such as to define, update, and/or manage one or more shelf stocking plans (e.g., a “plan-o-gram”) and/or inventory management protocols and/or processes.

In some embodiments, the system 1200 may be utilized to check, determine, and/or manage inventory and/or stocking in a retail environment. The user device 1202 may be utilized, for example, to capture an image (depicted as having a field-of-view represented by dashed lines in FIG. 12) of the plurality of units of product 1260a-b (and/or the shelves 1270a-b), such as to determine whether the shelves 1270a-b are correctly and/or sufficiently stocked. According to some embodiments, the image data from the user device 1202 and/or location data from the user device 1202 and/or the plurality of sensor devices 1208b, may be transmitted to (and accordingly received by) the controller device 1210. In some embodiments, such as in the case that the plurality of sensor devices 1208b comprise iBeacons® or other Bluetooth®, NFC, and/or other short-range communication devices, the location of the user device 1202 within a retail environment may be determined. In such a manner, for example, an aisle and/or other interior locational reference associated with the user device 1202 may be determined. In some embodiments, the locational information may be utilized to determine a location and/or direction of the field-of-view. In some embodiments, the image data may be utilized to determine the interior location, confirm and/or adjust a location determined from the location data, and/or may be utilized to determine the direction of the field-of-view. Image data such as shelf numbers and/or product types and/or arrangements may be utilized by the controller device 1210, for example, to identify the shelves 1270a-b (e.g., amongst a plurality of possible shelves in a store). The controller device 1210 may, for example, compare the image data (and/or portions thereof) to image data stored in the database 1240 to determine one or more image artifact matches indicative of a known location in a store (or warehouse, or other product storage area).

According to some embodiments, the database 1240 may store product stocking plans, arrangements, and/or guidelines for the particular shelves 1270a-b. Each shelf 1270a-b may, for example, be actually or virtually segmented or divided into different zones in which different product types are supposed to be stocked (e.g., a “plan-o-gram”). A first shelf 1270a, for example, may be divided into three (3) product placement zones 1270a-1, 1270a-2, 1270a-3, and/or a second shelf 1270b may be divided into two (2) product placement zones 1270b-1, 1270b-2. Stocking guidelines may dictate, as an example, that a first type of product should be stocked in a first product placement zone 1270a-1 of the first shelf 1270a, a second type of product should be stocked in a second product placement zone 1270a-2 of the first shelf 1270a, and a third type of product should be stocked in a third product placement zone 1270a-3 of the first shelf 1270a. According to some embodiments, the stored guidelines and/or placement rules may require that products from a first manufacturer be placed in a first product placement zone 1270b-1 of the second shelf 1270b and/or that products from a second manufacturer be placed in a second product placement zone 1270b-2 of the second shelf 1270b.

In some embodiments, the image data may be analyzed (e.g., by the controller device 1210 and/or the user device 1202) to determine whether the actual stocking of the shelves 1270a-b is in compliance with the desired plan(s) stored in the database 1240. The image data corresponding to the first shelf 1270a, for example, may be analyzed to determine that a first unit of product 1260a-1 of the desired first type of product is indeed stored in the first product placement zone 1270a-1 of the first shelf 1270a. The image data may also or alternatively be analyzed to determine that a second unit of product 1260a-2 of the desired second type of product is incorrectly stored in the first product placement zone 1270a-1 of the first shelf 1270a (e.g., with (on top of, behind, and/or next to) the first unit of product 1260a-1 of the desired first type of product). As depicted by the arrow in FIG. 12, it may be suggested (e.g., by the controller device 1210 and/or the user device 1202—e.g., via output of the user device 1202 and/or to a user of the user device 1202) that the second unit of product 1260a-2 be moved to the second product placement zone 1270a-2 of the first shelf 1270a—e.g., in accordance with the stored plan-o-gram. According to some embodiments, it may be determined that due to the relocation of the second unit of product 1260a-2, room for another unit of the first type of product is available in the first product placement zone 1270a-1 of the first shelf 1270a. In such a case, it may be suggested (e.g., by the controller device 1210 and/or the user device 1202—e.g., via output of the user device 1202 and/or to the user of the user device 1202) that another unit of the first type of product be ordered, or another such unit may automatically be ordered or indicated is required for restocking. In some embodiments, the image data may be analyzed to reveal that a third unit of product 1260a-3a and a fourth unit of product 1260a-3b of the desired third type of product are stored correctly in the third product placement zone 1270a-3 of the first shelf 1270a.

According to some embodiments, the image data corresponding to the second shelf 1270b may be analyzed to determine that while a unit of product 1260b-1 of a first manufacturer is stored in a first product placement area 1270b-1 of the second shelf 1270b, a unit of product 1260b-2 is stored in a second product placement area 1270b-2 of the second shelf 1270b. In the case that the units or product 1260b-1, 1260b-2 from the two different manufacturers are not desired for adjacent storage (e.g., pursuant to rules stored in the database 1240 and/or based on data received from the manufacturer device 1206), it may be suggested (e.g., by the controller device 1210 and/or the user device 1202—e.g., via output of the user device 1202 and/or to the user of the user device 1202) that one or both of the units of product 1260b-1, 1260b-2 from the two different manufacturers be relocated and/or removed from the second shelf 1270b. The various suggestions regarding product placement and/or stocking/restocking may be output to the user in a variety of manners. In some embodiments, suggestions may be output via an ARR interface such as one or more of the interfaces 220, 620, 820, 1020, 1320, 1420 of FIG. 2, FIG. 6, FIG. 8, FIG. 10, FIG. 13, and/or FIG. 14 herein.

Fewer or more components 1202, 1204, 1206, 1208b, 1210, 1240, 1260a-b, 1270a-b and/or various configurations of the depicted components 1202, 1204, 1206, 1208b, 1210, 1240, 1260a-b, 1270a-b may be included in the system 1200 without deviating from the scope of embodiments described herein. In some embodiments, the components 1202, 1204, 1206, 1208b, 1210, 1240, 1260a-b, 1270a-b may be similar in configuration and/or functionality to similarly named and/or numbered components as described herein. In some embodiments, the system 1200 (and/or portion thereof) may be utilized by and/or in conjunction with an ARR application program and/or platform programmed and/or otherwise configured to execute, conduct, and/or facilitate the methods 400, 900, 1500 of FIG. 4, FIG. 9, and/or FIG. 15, and/or portions or combinations thereof, described herein.

Turning now to FIG. 13, for example, a perspective diagram of an example system 1300 according to some embodiments is shown. In some embodiments, the system 1300 may comprise user device 1302 having a display device 1316 that outputs an interface 1320. The interface 1320 may, for example, comprise output from an ARR application that is programmed to enhance real-world images with augmented and/or supplemental content (e.g., highlighting 1322a-b and/or image enhancements 1326a-e). As depicted, for example, the interface 1320 (via the display device 1316) displays an image of a retail product (or other product, such as a pharmacy, storage area, and/or warehouse) display comprising a plurality of units of product 1360a-d stored on a plurality of shelves 1370a-d. The user device 1302 may, in some embodiments, comprise a camera (not shown in FIG. 13) that captures an image in the direction opposite of the output of the interface 1320 (e.g., oriented opposite to the display device 1316 that outputs the interface 1320), allowing a user (not fully and/or explicitly shown in FIG. 13) to utilize the user device 1302 as a virtual reality ‘frame’ or lens through which the retail environment/shelves 1370a-d (or other real-world location) and/or units or product 1360a-d may be viewed. The interface 1320 may comprise, as depicted for example, a real-time image of the retail display behind the user device 1302 being held up by the user.

In some embodiments, the interface 1320 may be augmented with data supplemental to the real-time, real-world image data received by the camera and output via the display device 1316. The interface 1320 may comprise, for example, highlighting 1322a-b of one or more objects or features in the real-time image. As depicted, for example, a first highlighting 1322a alters the portion of the real-time image corresponding to a first unit of product 1360a. In such a manner, for example, the user's attention may be drawn to the first unit of product 1360a and/or the first highlighting 1322a may comprise an indication that the first unit of product 1360a has been locked-onto as an ARR target. In some embodiments, the first highlighting 1322a may change color, appearance, and/or animation based on whether the first unit of product 1360a has been identified as an ARR target (e.g., an image for which a stored representation in a database and associated supplemental content corresponds). In some embodiments, the first highlighting 1322a may indicate that the identified first unit of product 1360a does not belong in the position on a first shelf 1370a, in which the first unit of product 1360a is currently placed. In some embodiments, a selection of the first unit of product 1360a and/or the first highlighting 1322a via the interface 1320 may trigger an outputting of supplemental data related to the first unit of product 1360a such as an indication of where the first unit of product 1360a actually belongs.

According to some embodiments, a second highlighting 1322b may be configured to virtually surround and/or identify a second unit of product 1360b. The second highlighting 1322b may, in some embodiments, be implemented in response to input received (e.g., via the interface 1320 and/or via the user device 1302) from the user that indicates a desire to retrieve supplemental data related to the second unit of product 1360b (e.g., input associated with a portion of the image corresponding to the second unit of product 1360b). In such a manner, for example, a user may utilize the interface 1320 to easily and/or readily access supplemental data relating to individual desired units of product 1360a-d stored on the shelves 1370a-d. In some embodiments, the second highlighting 1322b may be provided to indicate that the second unit of product 1360b has (or will shortly—e.g., within a predetermined approaching time threshold) expired and/or passed (or is soon to pass) an associated best-by or other pertinent stocking and/or product characteristic date. According to some embodiments, the second highlighting 1322b may indicate that the second unit of product 1360b has been recalled and should accordingly be removed from the first shelf 1370a. In such a manner, for example, a user of the interface 1320 may readily view which units of product 1360a-d on the shelves 1370a-d are in need of replacement and/or removal.

In some embodiments, the interface 1320 may comprise other and/or additional enhancements to the real-time and/or real-world image output by the display device 1316. The interface 1320 may comprise, for example, a first image enhancement 1326a. In some embodiments, the first image enhancement 1326a may comprise an indication of an area on a second shelf 1370b where inventory is lacking. As depicted, for example, the first image enhancement 1326a may superimpose a shape, object, image, and/or other ARR feature over a portion of the image output by the interface 1320 that corresponds to an empty portion of the second shelf 1370b. In some embodiments, out of inventory items and/or improperly stocked items (e.g., items in the wrong shelf positions and/or items not properly “faced”; e.g., oriented) may accordingly be readily visible via the ARR interface 1320.

According to some embodiments, out of stock items and/or proper item placement may also or alternatively be indicated by use of a second image enhancement 1326b. The second image enhancement 1326b may comprise, for example, a ‘ghost’ image and/or outline of a missing item such as a dotted-line representation and/or a partially translucent or faded image of an item desired for the indicated location on a third shelf 1370c. In some embodiments, quantity, identifying, and/or other information regarding proper product placement may be indicated such as via a third image enhancement 1326c. The third image enhancement 1326c may, for example, indicate that an additional unit of a product (e.g., of a certain type, brand, etc.) should be added to the third shelf 1370c above the enhanced placard upon which the third image enhancement 1326c is superimposed.

In some embodiments, a fourth image enhancement 1326d may be utilized to indicate that a third unit of product 1360c should be removed from the location on a fourth shelf 1370d in which the third unit of product 1360c is currently placed. The third unit of product 1360c may be in the proper position on the fourth shelf 1370d but facing backward (e.g., a primary side and/or logo face of the third unit of product 1360c may not be facing the user device 1302), may be in an improper position but on the correct fourth shelf 1370d, or may be on an entirely incorrect shelf 1370a-d or even aisle. According to some embodiments, such as in the case that a store sets up a promotional ‘island’ and/or other display such as at the end of an aisle, utilizing products such as the third unit of product 1360c, the fourth image enhancement 1326d may indicate that the third unit of product 1360c should be relocated to such special display area.

According to some embodiments, a fifth image enhancement 1326e may comprise a directional arrow indicating that a fourth unit of product 1360d on the fourth shelf 1370d should be moved to a new position on the fourth shelf 1370d. In such a manner, for example, plan-o-gram and/or other product storage and/or placement guidelines may be quickly and easily realized by a user of the user device 1302 and corrective actions such as restocking, reordering, product removal, product placement, and/or product relocation may accordingly be easily and quickly effectuated by the user based on the ARR information provided via the interface 1320.

In some embodiments, any or all of the highlighting 1322a-b and image enhancements 1326a-e may be updated and/or modified (i) as the user and/or user device 1302 move, (ii) as time passes (e.g., the interface 1320 may change based on time windows and/or triggers), and/or (iii) based on information received from other devices (such as the merchant device 106, sensor devices 108a-c, and/or controller device 110 of FIG. 1). In some embodiments, any or all of the highlighting 1322a-b and the image enhancements 1326a-e may be defined and/or implemented based on (i) the location of the user and/or user device 1302, (ii) characteristics of the user and/or user device 1302 (e.g., user preferences, demographics, etc.), and/or (iii) image artifacts identified in the image (e.g., brand logos, store names, etc. —as described herein).

Fewer or more components 1302, 1316, 1320, 1322a-b, 1326a-e, 1360a-d, 1370a-d and/or various configurations of the depicted components 1302, 1316, 1320, 1322a-b, 1326a-e, 1360a-d, 1370a-d may be included in the system 1300 without deviating from the scope of embodiments described herein. In some embodiments, the components 1302, 1316, 1320, 1322a-b, 1326a-e, 1360a-d, 1370a-d may be similar in configuration and/or functionality to similarly named and/or numbered components as described herein. In some embodiments, the user device 1302 (and/or portion thereof) may comprise an ARR program and/or platform programmed and/or otherwise configured to execute, conduct, and/or facilitate the methods 400, 900, 1500 of FIG. 4, FIG. 9, and/or FIG. 15, and/or portions or combinations thereof, described herein.

Referring now to FIG. 14, a perspective diagram of an example system 1400 according to some embodiments is shown. In some embodiments, the system 1400 may comprise user device 1402 having a display device 1416 that outputs an interface 1420. The interface 1420 may, for example, comprise output from an ARR application that is programmed to enhance real-world images with augmented and/or supplemental content (e.g., highlighting 1422 and/or image enhancements 1426a-c). As depicted, for example, the interface 1420 (via the display device 1416) displays an image of a grocery store and/or other retail product aisle. The user device 1402 may, in some embodiments, comprise a camera (not shown in FIG. 14) that captures an image in the direction opposite of the output of the interface 1420 (e.g., oriented opposite to the display device 1416 that outputs the interface 1420), allowing a user (not fully and/or explicitly shown in FIG. 14) to utilize the user device 1402 as a virtual reality ‘frame’ or lens through which the aisle (or other real-world location) may be viewed. The interface 1420 may comprise, as depicted for example, a real-time image of the aisle behind the user device 1402 being held up by the user.

In some embodiments, the interface 1420 may be augmented with data supplemental to the real-time, real-world image data received by the camera and output via the display device 1416. The interface 1420 may comprise, for example, highlighting 1422 of one or more objects or features in the real-time image. As depicted, for example, the 1422 alters the portion of the real-time image corresponding to a unit of product 1460a. In such a manner, for example, the user's attention may be drawn to the unit of product 1460 and/or the highlighting 1422 may comprise an indication that the unit of product 1460 has been locked-onto as an ARR target. In some embodiments, the highlighting 1422 may change color, appearance, and/or animation based on whether the unit of product 1460 has been identified as an ARR target (e.g., an image for which a stored representation in a database and associated supplemental content corresponds). In some embodiments, the highlighting 1422 may indicate that the unit of product 1460 correspond to a product on a shopping (e.g., grocery) list associated with the user. In such a manner, for example, the user may simply point the user device 1402 down the aisle and quickly and easily spot products that are on the user's grocery list (e.g., automatically placed on the user's grocery list by a smart refrigerator and/or smart shelf such as the smart refrigerator 1108a and/or the smart shelf 1170 of FIG. 11 herein).

According to some embodiments, a first image enhancement 1426a may comprise an indicator relating to a shopping list of which the unit of product 1460 is a member. The interface 1420 may, for example, guide the user through the store from one product to the next until all items required for a shopping list have been acquired. As depicted, in some embodiments, the first image enhancement 1426a may comprise a numeric and/or hierarchical indicator that suggests to the user an order in which the desired products should be acquired. In some embodiments, a second image enhancement 1426b may comprise an animation such as the animated product depicted as hopping off a shelf and running across the aisle. In such a manner, for example, the user's attention may be focused on important products on the user's list, products having special pricing, and/or products for which promotional consideration has been provided for the benefit of appearing on the interface 1420.

In some embodiments, a third image enhancement 1426c may comprise a directional feature that informs the user which direction to take within a store (and/or inside another structure). Utilizing locational information from the user device 1402 and/or from sensor devices such as iBeacons® (not shown in FIG. 14), for example, the user's location may be pinpointed and compared with a predetermined shopping list routing (e.g., based on known locations of products in the store) to determine which way the user should turn and/or travel. According to some embodiments, the interface 1420 may provide a map interface (not shown) and/or a total estimated time until the shopping list is complete (also not shown)—e.g., based on the predetermined routing. In some embodiments, the routing may comprise different alternate routes based on different routing methods, similar to known methods of utilizing different variables to plan different travel routes for automobiles by GPS navigation devices. In some embodiments, such as in the case that the user is in an unknown store and/or a store for which product data is incomplete (or entirely unavailable), the image data captured by the user device 1402 may be analyzed as the user travels through the store to determine which products appearing on shelves and/or in or along the aisles are on the user's list.

In some embodiments, any or all of the highlighting 1422 and image enhancements 1426a-c may be updated and/or modified (i) as the user and/or user device 1402 move, (ii) as time passes (e.g., the interface 1420 may change based on time windows and/or triggers), and/or (iii) based on information received from other devices (such as the merchant device 106, sensor devices 108a-c, and/or controller device 110 of FIG. 1). In some embodiments, any or all of the highlighting 1422 and the image enhancements 1426a-c may be defined and/or implemented based on (i) the location of the user and/or user device 1402, (ii) characteristics of the user and/or user device 1402 (e.g., user preferences, demographics, etc.), and/or (iii) image artifacts identified in the image (e.g., brand logos, store names, etc. —as described herein).

Fewer or more components 1402, 1416, 1420, 1422, 1426a-c, 1460 and/or various configurations of the depicted components 1402, 1416, 1420, 1422, 1426a-c, 1460 may be included in the system 1400 without deviating from the scope of embodiments described herein. In some embodiments, the components 1402, 1416, 1420, 1422, 1426a-c, 1460 may be similar in configuration and/or functionality to similarly named and/or numbered components as described herein. In some embodiments, the user device 1402 (and/or portion thereof) may comprise an ARR program and/or platform programmed and/or otherwise configured to execute, conduct, and/or facilitate the methods 400, 900, 1500 of FIG. 4, FIG. 9, and/or FIG. 15, and/or portions or combinations thereof, described herein

Turning now to FIG. 15, a flow diagram of a method 1500 according to some embodiments is shown. In some embodiments, the method 1500 may be implemented, facilitated, and/or performed by or otherwise associated with the systems 1100, 1200 of FIG. 11 and/or FIG. 12 herein (and/or portions thereof, such as the user devices 1102, 1202 and/or the controller devices 1110, 1210 thereof). In some embodiments, the method 1500 may be implemented via a GUI such as one or more of the interfaces 220, 620, 820, 1020, 1320, 1420 of FIG. 2, FIG. 6, FIG. 8, FIG. 10, FIG. 13, and/or FIG. 14 herein.

According to some embodiments, the method 1500 may comprise capturing (e.g., by a processing device) image of contents of shelf, at 1502. A portable image device and/or an image device coupled to the shelf may, for example, capture an image of a plurality of products (and accordingly product positions) on the shelf. In some embodiments, the image device may comprise one or more cameras coupled to a shelf edge and oriented to capture images of products stored above and/or below the coupling location. According to some embodiments, the image device(s) may be coupled to a shelf and/or other structure and oriented to capture images of a shelf opposite to the coupling location. A camera coupled to a shelf on one side of an aisle may, for example, be oriented to capture images of one or more shelves across the aisle from the shelf to which the camera is coupled. According to some embodiments, such as in the case that the camera comprises and/or is part of a mobile device, a designated shelf inventory image location may be established. Store personnel (in the case of a retail shelf image capture) or consumers (in the case of a consumer's pantry or refrigerator shelf) may be directed (e.g., via prompts output by a user device) to stand in a certain position and/or orient the camera in a particular direction and/or manner (e.g., to achieve the desired shelf image results). In the example of store inventory, an image-based stocking location may be designated for a shelf and/or set of shelves by a floor decal and/or other visual indicator of appropriate positioning. According to some embodiments, such as in the case that the camera is coupled to capture images of a refrigerator shelf, the camera may be coupled to the inside of a refrigerator cabinet and/or to an interior portion of a door of the refrigerator. In such a manner, for example, the camera may capture images of the contents of the refrigerator even when the refrigerator door is closed. Indeed, the camera may be triggered to capture shelf inventory images based on refrigerator door opening and/or closing.

In some embodiments, the method 1500 may comprise comparing (e.g., by the processing device) stored images to the captured image, at 1504. Stored images of various products, logos, etc. may, for example, be compared to portions of the image to determine (i) what types of products are stored on the shelf, (ii) what brands of products are stored on the shelf, (iii) quantities (e.g., counts) of various types/brands of units of products stored on the shelf, (iv) remaining quantities for particular units of product stored on the shelf, and/or (v) characteristic information descriptive of particular units of product stored on the shelf (e.g., expiration dates, best-by dates, lots, runs, batches, originating canning and/or bottling facilitates, etc.). In some embodiments, the stored images may comprise images of products from various angles such that captured images taken from shelf-mounted cameras may be utilized to compare product data even in cases where imagery is not captured from a traditional frontal orientation.

According to some embodiments, the method 1500 may comprise determining (e.g., by the processing device) an inventory of the shelf, at 1506. The product identities and/or unit counts determined at 1504, for example, may be utilized to determine total inventory counts for units of different types of products stored on the shelf. The inventory may include, in some embodiments, inventory counts by product type, manufacturer and/or brand, and/or product type volume and/or mass quantities (e.g., cups, ounces, pounds, milliliters, grams, etc.). In some embodiments, the inventory figures may be utilized to predict product type usage rates and/or restocking levels required to meet certain requirements (e.g., holiday rush periods in a store or anticipated and/or scheduled recipe preparation at a consumer's home or restaurant). Inventory levels may be determined at intervals and/or upon triggering events, for example, and may accordingly be analyzed with respect to inventory level changes over time. In such a manner, it may be determined that a family uses, on average, two (2) jars of peanut butter every month or that a restaurant consumes twenty (20) pounds of butter per week. Such rate of consumption figures may be utilized, in some embodiments, to predict remaining quantities of particular units of product stored on the shelf. According to some embodiments, images for products having translucent or clear packaging may be analyzed for indications of remaining quantities. An apparent current fill-level line around the sides of a plastic milk carton may be utilized, for example, to determine that approximately twenty percent (20%) of the original gallon remains at a current inventory imaging time. In some embodiments, predicted inventory depletion dates may be utilized in conjunction with zero inventory levels for various products to determine which products should be re-ordered, purchased, and/or added to a shopping list. Suggested, planned, and/or predicted purchase (e.g., grocery trip, restocking deliveries) dates may be utilized to plan the timing of the suggested restocking events.

Turning now to FIG. 16, a block diagram of an apparatus 1610 according to some embodiments is shown. In some embodiments, the apparatus 1610 may be similar in configuration and/or functionality to any of the controller devices 110, 510, 710, 1110, 1210 the user devices 102, 202, 502, 602, 702a-d, 1102, 1202, 1302, 1402 and/or the third-party device 106, 506a-b, 706, 1106, 1206 of FIG. 1, FIG. 2, FIG. 5, FIG. 6, FIG. 7, FIG. 11, and/or FIG. 12 herein. The apparatus 1610 may, for example, execute, process, facilitate, and/or otherwise be associated with the methods 400, 900, 1500 of FIG. 4, FIG. 9, and/or FIG. 15 and/or portions or combinations thereof. In some embodiments, the apparatus 1610 may comprise a processing device 1612, an input device 1614, an output device 1616, a communication device 1618, a memory device 1640, and/or a cooling device 1650. According to some embodiments, any or all of the components 1612, 1614, 1616, 1618, 1640, 1650 of the apparatus 1610 may be similar in configuration and/or functionality to any similarly named and/or numbered components described herein. Fewer or more components 1612, 1614, 1616, 1618, 1640, 1650 and/or various configurations of the components 1612, 1614, 1616, 1618, 1640, 1650 may be included in the apparatus 1610 without deviating from the scope of embodiments described herein.

According to some embodiments, the processor 1612 may be or include any type, quantity, and/or configuration of processor that is or becomes known. The processor 1612 may comprise, for example, an Intel® IXP 2800 network processor or an Intel® XEON™ Processor coupled with an Intel® E7501 chipset. In some embodiments, the processor 1612 may comprise multiple inter-connected processors, microprocessors, and/or micro-engines. According to some embodiments, the processor 1612 (and/or the apparatus 1610 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1610 comprises a server such as a blade server, necessary power may be supplied via a standard AC outlet, power strip, surge protector, and/or Uninterruptible Power Supply (UPS) device. According to some embodiments, the processor 1612 may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc.

In some embodiments, the input device 1614 and/or the output device 1616 are communicatively coupled to the processor 1612 (e.g., via wired and/or wireless connections and/or pathways) and they may generally comprise any types or configurations of input and output components and/or devices that are or become known, respectively. The input device 1614 may comprise, for example, a keyboard that allows an operator of the apparatus 1610 to interface with the apparatus 1610 (e.g., by a consumer, such as to utilize ARR interface to interact with and/or manage retail products as described herein). In some embodiments, the input device 1614 may comprise a sensor configured to provide information such as geospatial, image, and/or other location data to the apparatus 1610 and/or the processor 1612. The output device 1616 may, according to some embodiments, comprise a display screen and/or other practicable output component and/or device. The output device 1616 may, for example, provide an ARR interface (e.g., the interfaces 220, 620, 820, 1020, 1320, 1420 of FIG. 2, FIG. 6, FIG. 8, FIG. 10, FIG. 13, and/or FIG. 14 herein) via which a consumer can acquire and/or provide supplemental information descriptive of real-world products, locations, and/or other objects and/or to a store stockperson and/or other employee desiring to check, update, and/or manage products stocked on shelves. According to some embodiments, the input device 1614 and/or the output device 1616 may comprise and/or be embodied in a single device such as a touch-screen monitor.

In some embodiments, the communication device 1618 may comprise any type or configuration of communication device that is or becomes known or practicable. The communication device 1618 may, for example, comprise a Network Interface Card (NIC), a telephonic device, a cellular network device, a router, a hub, a modem, and/or a communications port or cable. In some embodiments, the communication device 1618 may be coupled to provide data to a remote mobile device, such as in the case that the apparatus 1610 is utilized to provide ARR supplemental data to a remote and/or mobile user device as described herein. The communication device 1618 may, for example, comprise a cellular telephone network transmission device that sends signals indicative of product stocking, restocking, ordering, purchasing, and/or locating data. According to some embodiments, the communication device 1618 may also or alternatively be coupled to the processor 1612. In some embodiments, the communication device 1618 may comprise an IR, RF, Bluetooth®, NFC, and/or Wi-Fi® network device coupled to facilitate communications between the processor 1612 and another device (such as a client device and/or a third-party device, not shown in FIG. 16).

The memory device 1640 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1640 may, according to some embodiments, store one or more of Augmented Retail Reality (ARR) instructions 1642-1, promotion instructions 1642-2, social network instructions 1642-3, smart appliance instructions 1642-4, user data 1644-1, location data 1644-2, image data 1644-3, product data 1644-4, and/or promotion data 1644-5. In some embodiments, the ARR instructions 1642-1, promotion instructions 1642-2, social network instructions 1642-3, and/or smart appliance instructions 1642-4 may be utilized by the processor 1612 to provide output information via the output device 1616 and/or the communication device 1618.

According to some embodiments, the ARR instructions 1642-1 may be operable to cause the processor 1612 to process the user data 1644-1, location data 1644-2, image data 1644-3, product data 1644-4, and/or promotion data 1644-5 in accordance with embodiments as described herein. User data 1644-1, location data 1644-2, image data 1644-3, product data 1644-4, and/or promotion data 1644-5 received via the input device 1614 and/or the communication device 1618 may, for example, be analyzed, sorted, filtered, decoded, decompressed, ranked, scored, plotted, and/or otherwise processed by the processor 1612 in accordance with the ARR instructions 1642-1. In some embodiments, user data 1644-1, location data 1644-2, image data 1644-3, product data 1644-4, and/or promotion data 1644-5 may be fed by the processor 1612 through one or more mathematical and/or statistical formulas and/or models in accordance with the ARR instructions 1642-1 to determine user and/or user device location (e.g., within a structure such as a store), identify locations, products, and/or other objects in image data received from a user and/or user device, determine supplemental data to provide, and/or provide data defining an ARR interface and/or display, as described herein.

In some embodiments, the promotion instructions 1642-2 may be operable to cause the processor 1612 to process the user data 1644-1, location data 1644-2, image data 1644-3, product data 1644-4, and/or promotion data 1644-5 in accordance with embodiments as described herein. User data 1644-1, location data 1644-2, image data 1644-3, product data 1644-4, and/or promotion data 1644-5 received via the input device 1614 and/or the communication device 1618 may, for example, be analyzed, sorted, filtered, decoded, decompressed, ranked, scored, plotted, and/or otherwise processed by the processor 1612 in accordance with the promotion instructions 1642-2. In some embodiments, user data 1644-1, location data 1644-2, image data 1644-3, product data 1644-4, and/or promotion data 1644-5 may be fed by the processor 1612 through one or more mathematical and/or statistical formulas and/or models in accordance with the promotion instructions 1642-2 to determine a promotion associated with a product, location, and/or other object, as described herein.

According to some embodiments, the social network instructions 1642-3 may be operable to cause the processor 1612 to process the user data 1644-1, location data 1644-2, image data 1644-3, product data 1644-4, and/or promotion data 1644-5 in accordance with embodiments as described herein. User data 1644-1, location data 1644-2, image data 1644-3, product data 1644-4, and/or promotion data 1644-5 received via the input device 1614 and/or the communication device 1618 may, for example, be analyzed, sorted, filtered, decoded, decompressed, ranked, scored, plotted, and/or otherwise processed by the processor 1612 in accordance with the social network instructions 1642-3. In some embodiments, user data 1644-1, location data 1644-2, image data 1644-3, product data 1644-4, and/or promotion data 1644-5 may be fed by the processor 1612 through one or more mathematical and/or statistical formulas and/or models in accordance with the social network instructions 1642-3 to determine user-defined and/or user-selected product, location, and/or object data, select user devices to which such data should be provided, receive social networking votes and/or ratings or suggestions, and/or activate social networking promotions, as described herein.

In some embodiments, the smart appliance instructions 1642-4 may be operable to cause the processor 1612 to process the user data 1644-1, location data 1644-2, image data 1644-3, product data 1644-4, and/or promotion data 1644-5 in accordance with embodiments as described herein. User data 1644-1, location data 1644-2, image data 1644-3, product data 1644-4, and/or promotion data 1644-5 received via the input device 1614 and/or the communication device 1618 may, for example, be analyzed, sorted, filtered, decoded, decompressed, ranked, scored, plotted, and/or otherwise processed by the processor 1612 in accordance with the smart appliance instructions 1642-4. In some embodiments, user data 1644-1, location data 1644-2, image data 1644-3, product data 1644-4, and/or promotion data 1644-5 may be fed by the processor 1612 through one or more mathematical and/or statistical formulas and/or models in accordance with the smart appliance instructions 1642-4 to determine and/or manage product inventory, restocking, and/or ordering and/or to facilitate product preparation (such as measuring, cooking, etc.), as described herein.

In some embodiments, the apparatus 1610 may comprise the cooling device 1650. According to some embodiments, the cooling device 1650 may be coupled (physically, thermally, and/or electrically) to the processor 1612 and/or to the memory device 1640. The cooling device 1650 may, for example, comprise a fan, heat sink, heat pipe, radiator, cold plate, and/or other cooling component or device or combinations thereof, configured to remove heat from portions or components of the apparatus 1010.

Any or all of the exemplary instructions and data types described herein and other practicable types of data may be stored in any number, type, and/or configuration of memory devices that is or becomes known. The memory device 1640 may, for example, comprise one or more data tables or files, databases, table spaces, registers, and/or other storage structures. In some embodiments, multiple databases and/or storage structures (and/or multiple memory devices 1640) may be utilized to store information associated with the apparatus 1610. According to some embodiments, the memory device 1640 may be incorporated into and/or otherwise coupled to the apparatus 1610 (e.g., as shown) or may simply be accessible to the apparatus 1610 (e.g., externally located and/or situated).

Referring to FIG. 17A, FIG. 17B, FIG. 17C, FIG. 17D, and FIG. 17E, perspective diagrams of exemplary data storage devices 1740a-e according to some embodiments are shown. The data storage devices 1740a-e may, for example, be utilized to store instructions and/or data such as the ARR instructions 1642-1, promotion instructions 1642-2, social network instructions 1642-3, smart appliance instructions 1642-4, user data 1644-1, location data 1644-2, image data 1644-3, product data 1644-4, and/or promotion data 1644-5, each of which is described in reference to FIG. 16 herein. In some embodiments, instructions stored on the data storage devices 1740a-e may, when executed by a processor, cause the implementation of and/or facilitate the methods 400, 900, 1500 of FIG. 4, FIG. 9, and/or FIG. 15 herein, and/or portions and/or combinations thereof.

According to some embodiments, the first data storage device 1740a may comprise one or more various types of internal and/or external hard drives. The first data storage device 1740a may, for example, comprise a data storage medium 1746 that is read, interrogated, and/or otherwise communicatively coupled to and/or via a disk reading device 1748. In some embodiments, the first data storage device 1740a and/or the data storage medium 1746 may be configured to store information utilizing one or more magnetic, inductive, and/or optical means (e.g., magnetic, inductive, and/or optical-encoding). The data storage medium 1746, depicted as a first data storage medium 1746a for example (e.g., breakout cross-section “A”), may comprise one or more of a polymer layer 1746a-1, a magnetic data storage layer 1746a-2, a non-magnetic layer 1746a-3, a magnetic base layer 1746a-4, a contact layer 1746a-5, and/or a substrate layer 1746a-6. According to some embodiments, a magnetic read head 1746a may be coupled and/or disposed to read data from the magnetic data storage layer 1746a-2.

In some embodiments, the data storage medium 1746, depicted as a second data storage medium 1746b for example (e.g., breakout cross-section “B”), may comprise a plurality of data points 1746b-2 disposed with the second data storage medium 1746b. The data points 1746b-2 may, in some embodiments, be read and/or otherwise interfaced with via a laser-enabled read head 1748b disposed and/or coupled to direct a laser beam (and/or other optical signal) through the second data storage medium 1746b.

In some embodiments, the second data storage device 1740b may comprise a CD, CD-ROM, DVD, Blu-Ray™ Disc, and/or other type of optically-encoded disk and/or other storage medium that is or becomes know or practicable. In some embodiments, the third data storage device 1740c may comprise a USB keyfob, dongle, and/or other type of flash memory data storage device that is or becomes know or practicable. In some embodiments, the fourth data storage device 1740d may comprise RAM of any type, quantity, and/or configuration that is or becomes practicable and/or desirable. In some embodiments, the fourth data storage device 1740d may comprise an off-chip cache such as a Level 2 (L2) cache memory device. According to some embodiments, the fifth data storage device 1740e may comprise an on-chip memory device such as a Level 1 (L1) cache memory device.

The data storage devices 1740a-e may generally store program instructions, code, and/or modules that, when executed by a processing device cause a particular machine to function in accordance with one or more embodiments described herein. The data storage devices 1740a-e depicted in FIG. 17A, FIG. 17B, FIG. 17C, FIG. 17D, and FIG. 17E are representative of a class and/or subset of computer-readable media that are defined herein as “computer-readable memory” (e.g., non-transitory memory devices as opposed to transmission devices or media).

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein. According to some embodiments, a processor may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc. “Processing devices”, for example, specifically exclude software-only objects, modules, and/or components.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present embodiments can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

In some embodiments. a method may comprise capturing an image from a mobile device of a user; determining, by the mobile device and from the image, that an image artifact in the image matches a promotion image on the mobile device, transmitting, to a server device, information identifying the image, identifying, by the server device, a promotion associated with the promotion information stored in the database, and determining, by the server device and in response to the identifying, a promotion. While many embodiments herein are described with reference to a server device identifying a product (and/or location or object) from image data, in some embodiments, a user device may conduct the identifying (of the product and/or the supplemental content thereof). The user device may be periodically loaded with location-based portions of a database, for example, that allow the user device to identify product, locations, and/or objects known to be in proximity to (and/or in a region of) the user device. In such a manner, for example, even if connectivity to the server is lost for some period of time, the user device may be able to operate in accordance with embodiments described herein due to data pre-loaded (e.g., prior to the outage) onto the user device.

According to some embodiments, a method may comprise capturing, by a camera device in communication with a processing device, a first image of contents of a shelf, comparing, by the processing device, the first image of the contents of the shelf with stored images of products, and determining, by the processing device and based on the comparing, an inventory of the shelf. In some embodiments, the method may further comprise capturing, by the camera device and after the capturing of the first image of the contents of the shelf, a second image of contents of a shelf. In some embodiments, the method may further comprise comparing, by the processing device, the second image of the contents of the shelf with the stored images of products, an determining, by the processing device and based on the comparing of the second image to the stored images, an updated inventory of the shelf. In some embodiments, the method may further comprise comparing, by the processing device, the second image of the contents of the shelf with the first image of the contents of the shelf, and determining, by the processing device and based on the comparing of the second image to the first image, an updated inventory of the shelf. In some embodiments, the method may further comprise determining, based on the updated inventory, that an additional unit of a product should be purchased, and adding the additional unit of product to an electronic list.

In some embodiments, the method may further comprise comparing the inventory of the shelf to a determining, based on the comparing of the inventory of the shelf to the predetermined inventory, that at least one unit of product is missing from the shelf, and adding the missing at least one unit of product to an electronic list. In some embodiments, the shelf may comprise a plurality of identifiable product placement zones and wherein the predetermined inventory comprises a plurality of corresponding product placement guidelines, and the comparing of the inventory of the shelf to the predetermined inventory may comprise identifying one of the product placement zones, determining a type of a unit of product stored in the identified one of the product placement zones, determining, based on the product placement guideline corresponding to the identified one of the product placement zones, that an appropriate type of product for the identified one of the product placement zones does not match the type of the unit of product stored in the identified one of the product placement zones, and outputting an indication that the identified one of the product placement zones contains an incorrect type of product.

In some embodiments, the method may further comprise outputting a real-time image of the shelf, and superimposing, on the real-time image, at least one indication of a type of product that is desired to be stored on a particular portion of the shelf. In some embodiments, the indication of the type of product that is desired to be stored on the particular portion of the shelf may comprise a digital representation of a unit of the desired type of product and the superimposing comprises positioning the digital representation in a portion of the real-time image that corresponds to the particular portion of the shelf. In some embodiments, the particular portion of the shelf may comprise an empty portion of the shelf. In some embodiments, the camera device may be coupled to the shelf.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
receiving, by a server device, an image from a remote mobile device of a user;
determining, by the server device and from the image, that an image artifact in the image matches a promotion image stored in a database;
identifying, by the server device, a promotion associated with the promotion image stored in the database; and
causing, by the server device and in response to the identifying, a display device of the remote mobile device to output an indication of the promotion.

2. The method of claim 1, further comprising:
receiving, by the server device and from the remote mobile device of the user, an indication of an activation of the promotion by the user; and
transmitting, by the server device and to a merchant device of a merchant associated with the image artifact in the image, a payment authorization assigned to the user, the payment authorization being defined by the activated promotion.

3. The method of claim 1, wherein the image received from the remote mobile device of the user comprises a video image.

4. The method of claim 1, wherein the image artifact comprises business name.

5. The method of claim 1, wherein the image artifact comprises a brand logo.

6. The method of claim 1, wherein the image artifact comprises a trademark.

7. The method of claim 1, wherein the causing comprises transmitting a command to the remote mobile device, the command comprising an instruction defining the output of the indication of the promotion.

8. The method of claim 1, wherein the indication of the promotion comprises a highlighting of the image artifact on the display device of the remote mobile device.

9. The method of claim 1, wherein the indication of the promotion comprises an animation of the image artifact on the display device of the remote mobile device.

10. The method of claim 1, further comprising:
determining, by the server device, a location of the remote mobile device; and
determining, by the server device and based on the location of the remote mobile device, a value for a parameter defining at least one portion of the promotion.

11. The method of claim 10, wherein the causing of the display device of the remote mobile device to output the indication of the promotion comprises a causing of the display device of the remote mobile device to output an indication of the value for the parameter defining the at least one portion of the promotion.

12. A method, comprising:
acquiring, by a camera device of a user, an image of a location, the image comprising a plurality of image artifacts;
transmitting, by the camera device and to a remote server device, the plurality of image artifacts;
receiving, by the camera device and from the server device, an indication that one of the image artifacts from the plurality of image artifacts comprises a promotional trigger;
outputting, by the camera device and to the user, the image of the location; and
superimposing, in the output image and over the one of the image artifacts from the plurality of image artifacts that comprises the promotional trigger, by the camera device and in response to the receiving, a graphic representing a retail promotion.

13. The method of claim 12, further comprising:
receiving, by the camera device, an input comprising a selection of the superimposed graphic; and
transmitting, by the camera device and in response to the receiving of the selection of the superimposed graphic, an indication of an activation of the retail promotion.

14. The method of claim 12, wherein the graphic comprises a highlighting of the one of the image artifacts from the plurality of image artifacts that comprises the promotional trigger.

15. The method of claim 12, wherein the one of the image artifacts from the plurality of image artifacts that comprises the promotional trigger comprises at least one of (i) a name of a business, (ii) a logo of the business, (iii) a trademark of the business, (iv) a trade dress feature of the business, and (v) an architectural feature of a location of the business.

16. The method of claim 15, wherein the graphic comprises a replacement for the one of the image artifacts from the plurality of image artifacts that comprises the promotional trigger.

17. The method of claim 15, wherein the graphic comprises an animation of a product available for sale via the business.

18. A method, comprising:
receiving, by a processing device of a first mobile electronic device of a first user, and from an image input device, image data descriptive of a product;
determining, by the processing device and based on the image data, supplemental content descriptive of the product, the supplemental content being stored in a database;
generating, by the processing device, an image overlay based on the supplemental content; and
superimposing, by the processing device, the image overlay on a real-time image of the product output by the first mobile electronic device.

19. The method of claim 18, further comprising:
receiving, via the image overlay, input from the first user; and
updating, based on the input from the first user, the supplemental content stored in the database.

20. The method of claim 19, wherein the input from the first user comprises a rating of the product.

21. The method of claim 19, wherein the input from the first user comprises a recommendation of the product.

22. The method of claim 19, wherein the input from the first user comprises a user-defined description of the product.

23. The method of claim 19, wherein the input from the first user comprises a user-recommended promotion for the product.

24. The method of claim 19, wherein the input from the first user comprises a user-defined promotion for the product.

25. The method of claim 19, further comprising:
identifying a second user associated with the first user; and
transmitting, to a second mobile electronic device of the second user, an indication of the updating of the supplemental content.

26. The method of claim 25, wherein the identifying of the second user, comprises:
determining, based on social network data stored in a database, a relationship between the first user and the second user.

27. The method of claim 25, wherein the identifying of the second user, comprises:
determining a location of the first mobile electronic device; and
determining that the second mobile electronic device is within a predetermined proximity of the first mobile electronic device.
